(19) United States
(12) Patent Application Publication
(10) Pub. No.: US 2025/0312692 A1
(43) Pub. Date: Oct. 9, 2025

(54) INFORMATION PROCESSING SYSTEM AND INFORMATION PROCESSING METHOD

(71) Applicant: NINTENDO CO., LTD., Kyoto (JP)

(72) Inventors: Naoya MORIMURA, Kyoto (JP); Masamichi SAKAINO, Kyoto (JP)

(21) Appl. No.: 19/092,556

(22) Filed: Mar. 27, 2025

(30) Foreign Application Priority Data
Apr. 5, 2024 (JP) 2024-061225

(51) Int. Cl. A63F 13/25; A63F 13/23; A63F 13/32; A63F 13/493

(52) U.S. Cl. CPC A63F 13/25; A63F 13/23; A63F 13/32; A63F 13/493

(57) ABSTRACT

An example of an information processing system causes a processor of a game apparatus to execute a game program for generating a first image and a second image. The information processing system includes a first game apparatus and a second game apparatus. In the first mode, the processor of the first game apparatus is configured to: acquire first input data based on an input to a controller device; execute the game program using the first input data as operation data; store the first image and the second image in a frame buffer; output the first image stored in the frame buffer to a display device; and transmit the second image stored in the frame buffer to the second game apparatus. The processor of the second game apparatus is configured to output the second image received from the first game apparatus to a display device.

### CROSS REFERENCE TO RELATED APPLICATION

This application claims priority to Japanese Patent Application No. 2024-061225, filed on Apr. 5, 2024, the entire contents of which are incorporated herein by reference.

### FIELD

This disclosure relates to an information processing system and an information processing method for displaying game images on a plurality of screens.

### BACKGROUND AND SUMMARY

There have been techniques for playing games between a plurality of information processing apparatuses, in which one of the plurality of information processing apparatuses is set as a parent apparatus and the other apparatuses are set as child apparatuses, and images are distributed from the parent apparatus to the child apparatuses.

However, there was room for improvement to play games in more diverse ways using an information processing system that has the function of distributing images from a parent apparatus to child apparatuses.

Therefore, the present application discloses an information processing system and an information processing method that have the function of distributing images from a parent apparatus to child apparatuses and that can play games in novel and diverse ways.

(1) An example of an information processing system that causes a processor of a game apparatus to execute a game program for performing a game process based on operation data to generate a first image to be displayed on a first screen and a second image to be displayed on a second screen, the information processing system comprising: a first game apparatus and a second game apparatus. The first game apparatus includes at least one processor, and is configured to: acquire input data based on an input to at least one of a controller device that is provided in the first game apparatus and a controller device that is connected to the first game apparatus; and output an image to one of a display device that is provided in the first game apparatus and a display device that is connected to the first game apparatus. The second game apparatus includes at least one processor, and is configured to: acquire input data based on an input to at least one of a controller device that is provided in the second game apparatus and a controller device that is connected to the second game apparatus; and output an image to one of a display device that is provided in the second game apparatus and a display device that is connected to the second game apparatus. The first game apparatus and the second game apparatus communicate with each other. In the first mode, the at least one processor of the first game apparatus is configured to: acquire first input data based on an input to one of the controller device that is provided in the first game apparatus and the controller device that is connected to the first game apparatus; execute the game program using the first input data as the operation data; store the first image and the second image in a frame buffer; output the first image stored in the frame buffer to the display device that is provided in the first game apparatus or the display device that is connected to the first game apparatus; and transmit the second image stored in the frame buffer to the second game apparatus. In the first mode, the at least one processor of the second game apparatus is configured to: output the second image received from the first game apparatus to the display device that is provided in the second game apparatus or the display device that is connected to the second game apparatus.

According to Configuration (1) above, it is possible to play a game in a novel way such that a two-screen game is played using two game apparatuses.

(2) In configuration (1) above, in the second mode, the at least one processor of the second game apparatus may be configured to: execute the game program using the first input data received from the first game apparatus as the operation data; store the first image and the second image in a frame buffer; output the first image stored in the frame buffer to the display device that is provided in the second game apparatus or the display device that is connected to the second game apparatus; and transmit the second image stored in the frame buffer to the first game apparatus. In the second mode, the at least one processor of the first game apparatus may be configured to: transmit the first input data to the second game apparatus; and output the second image received from the second game apparatus to the display device that is provided in the first game apparatus or the display device that is connected to the first game apparatus.

According to Configuration (2) above, it is possible to perform game operations on either of the two game apparatuses, thereby improving convenience.

(3) In configuration (2) above, the information processing system may be configured to switch between the first mode and the second mode by an instruction input. When transitioning from the first mode to the second mode, the at least one processor of the first game apparatus may transmit execution status data that indicates an execution status of the game program to the second game apparatus; and the at least one processor of the second game apparatus may resume execution of the game program based on the received execution status data. When transitioning from the second mode to the first mode, the at least one processor of the second game apparatus may transmit the execution status data to the first game apparatus; and the processor of the first game apparatus may resume execution of the game program based on the received execution status data.

According to Configuration (3) above, the game apparatus on which game operations are performed can be switched, thereby improving convenience.

(4) Another example of an information processing system that causes a processor of a game apparatus to execute a game program for performing a game process based on operation data to generate a first image to be displayed on a first screen and a second image to be displayed on a second screen. The information processing system comprising: a first game apparatus and a second game apparatus. The first game apparatus includes at least one processor, and is configured to: acquire input data based on an input to at least one of a controller device that is provided in the first game apparatus and a controller device that is connected to the first game apparatus; and output an image to one of a display device that is provided in the first game apparatus and a display device that is connected to the first game apparatus. The second game apparatus includes at least one processor, and is configured to: acquire input data based on an input to at least one of a controller device that is provided in the second game apparatus and a controller device that is connected to the second game apparatus; and output an image to one of a display device that is provided in the second game apparatus and a display device that is connected to the second game apparatus. The first game apparatus and the second game apparatus communicate with each other. The at least one processor of the first game apparatus is configured to: acquire second input data from the second game apparatus; execute the game program using the second input data as the operation data; store the first image and the second image in a frame buffer; output the second image stored in the frame buffer to the display device that is provided in the first game apparatus or the display device that is connected to the first game apparatus; and transmit the first image stored in the frame buffer to the second game apparatus. The at least one processor of the second game apparatus is configured to: transmit the second input data based on an input to the controller device that is provided in the second game apparatus or the controller device that is connected to the second game apparatus to the first game apparatus; and output the first image received from the first game apparatus to the display device that is provided in the second game apparatus or the display device that is connected to the second game apparatus.

According to Configuration (4) above, it is possible to play a game in a novel way such that a two-screen game is played using two game apparatuses.

(5) Another example of an information processing system that causes a processor of a game apparatus to execute a game program for performing a game process based on operation data to generate a first image to be displayed on a first screen and a second image to be displayed on a second screen. The information processing system comprising: a first game apparatus and a second game apparatus. The first game apparatus includes at least one processor, and is configured to: acquire input data based on an input to at least one of a controller device that is provided in the first game apparatus and a controller device that is connected to the first game apparatus; and output an image to one of a display device that is provided in the first game apparatus and a display device that is connected to the first game apparatus. The second game apparatus includes at least one processor, and is configured to: acquire input data based on an input to at least one of a controller device that is provided in the second game apparatus and a controller device that is connected to the second game apparatus; and output an image to one of a display device that is provided in the second game apparatus and a display device that is connected to the second game apparatus. The first game apparatus and the second game apparatus communicate with each other. The at least one processor of the first game apparatus is configured to: acquire first input data based on an input to the controller device that is provided in the first game apparatus or the controller device that is connected to the first game apparatus; acquire second input data from the second game apparatus; execute the game program using the first input data and the second input data as the operation data; store the first image and the second image in a frame buffer; transmit one of the first image and the second image stored in the frame buffer to the second game apparatus; and output the other one of the first image and the second image stored in the frame buffer to the display device that is provided in the first game apparatus or the display device that is connected to the first game apparatus. The at least one processor of the second game apparatus is configured to: transmit the second input data based on an input to the controller device that is provided in the second game apparatus or the controller device that is connected to the second game apparatus to the first game apparatus; and output one of the first image and the second image received from the first game apparatus to the display device that is provided in the second game apparatus or the display device that is connected to the second game apparatus.

According to Configuration (5) above, it is possible to play a game in a novel way such that a two-screen game is played using two game apparatuses.

(6) In configuration (5) above, in the game program, inputs by a plurality of key operations may be used for giving instructions in the game. At least one of the first game apparatus and the second game apparatus may further include a touch panel, and touch input data of the touch panel may be included in at least one of the first input data and the second input data. At least one processor of the first game apparatus may be configured to: generate an image including an image indicating a key operation as either of the first image and the second image; and in response to an input of touching an image indicating a key operation, execute the game program as if the key operation has been performed.

According to Configuration (6) above, instructions for a two-screen game can be given by touch inputs, thereby improving the operability of the game.

Note that the present specification discloses an example of an information processing method (e.g., a game processing method) that is executed in the information processing system set forth in (1) to (6) above.

According to the information processing system or the information processing method described above, it is possible to play games in novel and diverse ways.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is a diagram showing an example of a non-limiting information processing apparatus in the state where a non-limiting left controller and a non-limiting right controller are attached to a non-limiting main body apparatus;

FIG. 2 is a diagram showing an example of the non-limiting information processing apparatus in the state where the non-limiting left controller and the non-limiting right controller are detached from the non-limiting main body apparatus;

FIG. 3 is a block diagram showing an example of the internal configuration of the non-limiting information processing apparatus;

FIG. 4 is a diagram showing an example of a non-limiting game system and is a diagram showing an overview of the non-limiting game system composed of a plurality of non-limiting information processing apparatuses performing the local communication with each other;

FIG. 5 is a diagram showing an example of the non-limiting game system and is a diagram showing an overview of the non-limiting game system composed of a plurality of non-limiting information processing apparatuses performing the Internet communication with each other;

FIG. 6 is a diagram showing an example of a game system in the first example;

FIG. 7 is a diagram showing an example of the game system when operating in the second mode;

FIG. 8 is a diagram showing an example of data stored in the non-limiting information processing apparatuses;

FIG. 9 is a flowchart showing an example of the flow of a parent apparatus process in the first example;

FIG. 10 is a flowchart showing an example of the flow of a child apparatus process in the first example;

FIG. 11 is a diagram showing an example of a game system in the second example;

FIG. 12 is a diagram showing an example of the game system operating in the fourth mode in the second example;

FIG. 13 is a flowchart showing an example of the flow of a parent apparatus process in the second example;

FIG. 14 is a flowchart showing an example of the flow of a child apparatus process when operating in the fourth mode in the second example;

FIG. 15 is a diagram showing an example of a game system in the third example;

FIG. 16 is a diagram showing an example of a game image displayed in the third example; and

FIG. 17 is a flowchart showing an example of the flow of a parent apparatus process in the third example.

### DETAILED DESCRIPTION OF NON-LIMITING EXAMPLE EMBODIMENTS

### Description of Information Processing Apparatus

An information processing apparatus used in an example of an exemplary embodiment is described below. An example of an information processing apparatus 1 includes a main body apparatus 2, a left controller 3, and a right controller 4. Each of the left controller 3 and the right controller 4 is configured to be attachable to and detachable from the main body apparatus 2. That is, the information processing apparatus 1 can be used as a unified apparatus obtained by attaching the left controller 3 and the right controller 4 to the main body apparatus 2. Further, the information processing apparatus 1 can also be used by detaching the left controller 3 and the right controller 4 from the main body apparatus 2. Hereinafter, the configuration of the information processing apparatus 1 according to the exemplary embodiment is described, and then, a game system including a plurality of information processing apparatuses 1 is described.

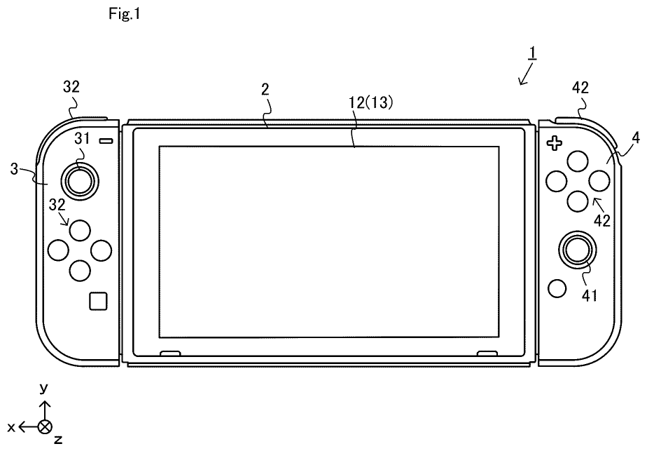

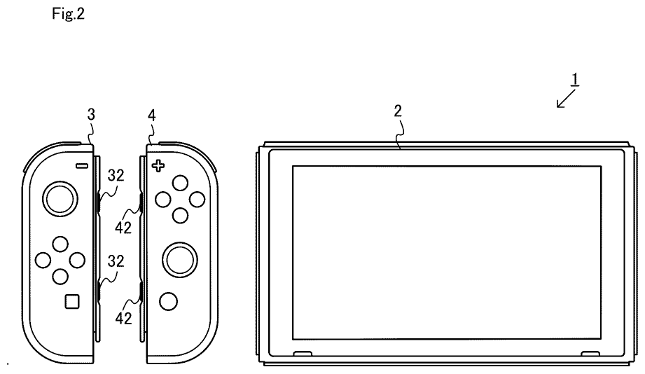

FIG. 1 is a diagram showing an example of the information processing apparatus 1 in the state where the left controller 3 and the right controller 4 are attached to the main body apparatus 2. FIG. 2 is a diagram showing an example of the information processing apparatus 1 in the state where the left controller 3 and the right controller 4 are detached from the main body apparatus 2. As shown in FIG. 1, each of the left controller 3 and the right controller 4 is attached to and unified with the main body apparatus 2. The main body apparatus 2 is an apparatus for performing various processes (e.g., game processing) in the information processing apparatus 1.

The main body apparatus 2 includes a display 12. The display 12 displays an image generated by the main body apparatus 2. The display 12 may be a display device of any type. For example, the display 12 may be a liquid crystal display device (LCD), or may be an organic EL display device.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

Each of the left controller 3 and the right controller 4 has a vertically long shape (e.g., a long shape in a y-axis direction shown in FIG. 1). In the state where each of the left controller 3 and the right controller 4 is detached from the main body apparatus 2, the controller can be held in the orientation in which the controller is vertically long, and can also be held in the orientation in which the controller is horizontally long.

The left controller 3 includes an analog stick 31 for a user to provide a direction input, and a plurality of operation buttons 32 for the user to perform a pressing operation. The right controller 4 includes an analog stick 41 for the user to provide a direction input, and a plurality of operation buttons 42 for the user to perform a pressing operation. Each of the left controller 3 and the right controller 4 may include an acceleration sensor and an angular velocity sensor within and be able to detect the motion and the orientation of the controller. Hereinafter, the left controller 3 and the right controller 4 are occasionally collectively referred to as a “first controller”.

The main body apparatus 2 to which the left controller 3 and the right controller 4 are attached (the information processing apparatus 1) is of a size that can be carried by the user. For example, the user performs a game operation using the left controller 3 and the right controller 4 by holding the left controller 3 unified with the main body apparatus 2 with their left hand and holding the right controller 4 unified with the main body apparatus 2 with their right hand and plays a game while viewing a game image displayed on the display 12 in front of the user. Hereinafter, a play form in which as described above, in the state where the left controller 3 and the right controller 4 are attached to the main body apparatus 2, the user performs a game operation using the left controller 3 and the right controller 4 and plays a game while viewing a game image displayed on the display 12 is occasionally referred to as a “mobile mode”.

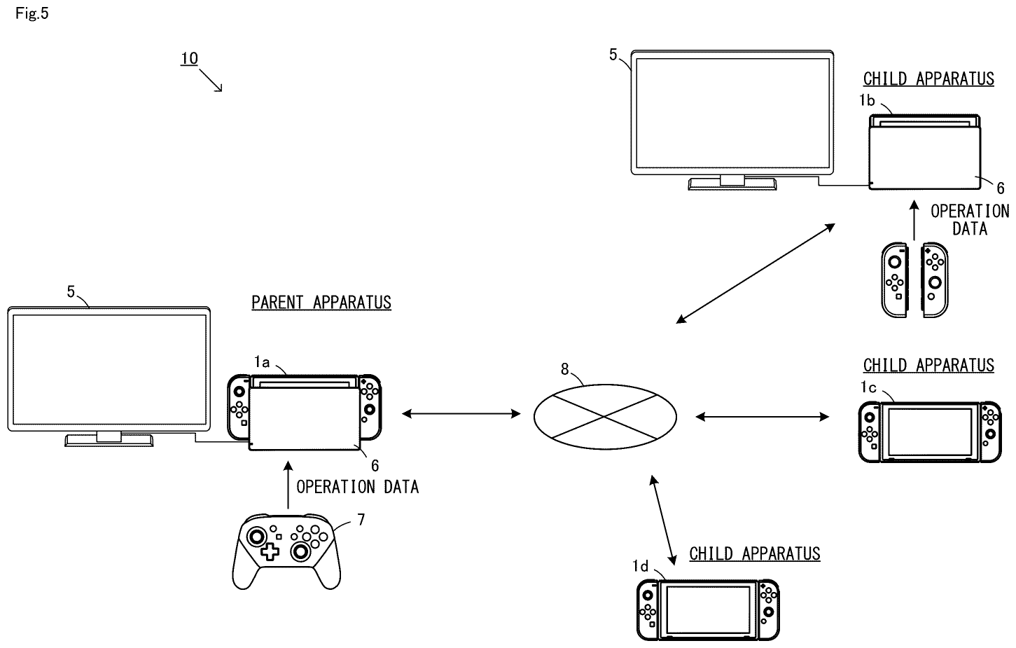

As shown in FIG. 2, the left controller 3 and the right controller 4 can be detached from the main body apparatus 2. In the state where the left controller 3 and the right controller 4 are detached from the main body apparatus 2, the left controller 3 and the right controller 4 are wirelessly connected to the main body apparatus 2. For example, a stand for standing the main body apparatus 2 is provided on a back surface of the main body apparatus 2. Using the stand, the user can place the main body apparatus 2 in the state where the main body apparatus 2 stands on a table so that the screen of the display 12 is almost perpendicular to the table. Alternatively, the user may place the main body apparatus 2 on the table so that the screen of the display 12 of the main body apparatus 2 faces up. The user can detach the left controller 3 and the right controller 4 from the main body apparatus 2, perform a game operation using the left controller 3 and/or the right controller 4, and play a game while viewing a game image displayed on the display 12 of the main body apparatus 2 placed on the table. Hereinafter, a play form in which as described above, the left controller 3 and the right controller 4 are wirelessly connected to the main body apparatus 2, and the user performs a game operation using the left controller 3 and/or the right controller 4 and plays a game while viewing a game image displayed on the display 12 is occasionally referred to as a “table mode”. To the main body apparatus 2, a second controller 7 (see FIG. 5) different from the left controller 3 and the right controller 4 may be able to be wirelessly connected. The second controller may be a controller that can be operated by the user by holding the controller with both hands. A play form in which as described above, the second controller is wirelessly connected to the main body apparatus 2, and the user performs a game operation using the second controller and plays a game while viewing a game image displayed on the display 12 is also referred to as a “table mode”. Hereinafter, the first controller and the second controller are occasionally collectively referred to as a “controller”.

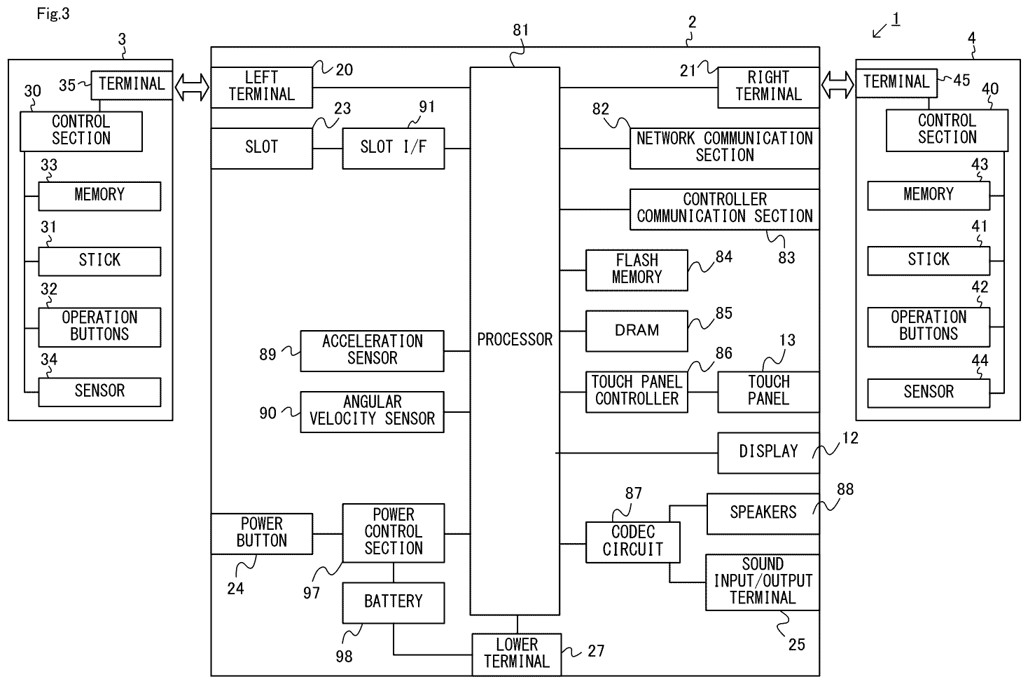

The user can also connect the main body apparatus 2 to a stationary monitor (e.g., television) 5 via a cradle 6 and play a game while viewing a game image displayed on the stationary monitor 5 (see FIG. 5). In the main body apparatus 2, a lower terminal 27 (see FIG. 3) for connecting to the cradle 6 is provided. The main body apparatus 2 is connected to the stationary monitor 5 in a wired manner via the cradle 6. A play form in which as described above, the user plays a game while viewing an image displayed on the external stationary monitor 5 different from the display 12 is occasionally referred to as a “stationary mode”. In a case where the information processing apparatus 1 operates in the stationary mode, the first controller (the left controller 3 and the right controller 4) may be detached from the main body apparatus 2 and wirelessly connected to the main body apparatus 2, and the user may perform a game operation using the first controller. Alternatively, in a case where the information processing apparatus 1 operates in the stationary mode, in the state where the left controller 3 and the right controller 4 are attached to the main body apparatus 2, another first controller or the second controller may be wirelessly connected to the main body apparatus 2, and the user may perform a game operation using the first controller or the second controller.

Next, the internal configuration of the information processing apparatus 1 is described. FIG. 3 is a block diagram showing an example of the internal configuration of the information processing apparatus 1.

As shown in FIG. 3, the main body apparatus 2 includes a processor 81. The processor 81 is an information processing section for executing various types of information processing to be executed by the main body apparatus 2. For example, the processor 81 may be composed of one or more CPUs (Central Processing Units), or may be composed of a SoC (System-on-a-chip) including one or more CPUs and one or more GPUs (Graphics Processing Units). The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, the network communication section 82 can directly wirelessly communicate with another main body apparatus 2 present in the communication range of this main body apparatus 2 using a predetermined communication method (e.g., a communication method based on a unique protocol or a method compliant with the Wi-Fi standard). Via a wireless LAN access point present in the communication range of this main body apparatus 2, the network communication section 82 may also be able to communicate with another main body apparatus 2 connected to a local area network including the access point using a method compliant with the Wi-Fi standard. Here, such direct communication with another main body apparatus 2 and such communication in a local area network via a wireless LAN access point are referred to as “local communication”. The network communication section 82 can connect to the Internet by connecting to a wireless LAN using a method compliant with the Wi-Fi standard, and can communicate with another apparatus connected to the Internet. The main body apparatus 2 may be able to connect to a wired LAN, and may be able to connect to the Internet via the wired LAN. For example, the main body apparatus 2 may be able to connect to the wired LAN via the cradle 6. Here, such communication with another apparatus via the Internet is referred to as “Internet communication”.

The main body apparatus 2 includes a controller communication section 83. The controller communication section 83 is connected to the processor 81. The controller communication section 83 wirelessly communicates with the left controller 3 and/or the right controller 4. The controller communication section 83 can also wirelessly communicate with the second controller. The communication method between the main body apparatus 2 and the left controller 3 and the right controller 4 (or the second controller) is optional. In the exemplary embodiment, the controller communication section 83 performs communication compliant with the Bluetooth (registered trademark) standard with the left controller 3 and with the right controller 4.

The processor 81 is connected to a left terminal 20, a right terminal 21, and a lower terminal 27. When performing wired communication with the left controller 3, the processor 81 transmits data to the left controller 3 via the left terminal 20 and also receives operation data from the left controller 3 via the left terminal 20. Further, when performing wired communication with the right controller 4, the processor 81 transmits data to the right controller 4 via the right terminal 21 and also receives operation data from the right controller 4 via the right terminal 21. Further, when communicating with the cradle 6, the processor 81 transmits data to the cradle 6 via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle 6, the main body apparatus 2 can output data (e.g., image data or sound data) to the stationary monitor 5 or the like via the cradle 6.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. Based on a signal from the touch panel 13, the touch panel controller 86 generates, for example, data indicating the position where a touch input is provided. Then, the touch panel controller 86 outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

Further, the main body apparatus 2 includes an acceleration sensor 89. In the exemplary embodiment, the acceleration sensor 89 detects the magnitudes of accelerations along predetermined three axial (e.g., xyz axes shown in FIG. 1) directions. It should be noted that the acceleration sensor 89 may detect an acceleration along one axial direction or accelerations along two axial directions.

Further, the main body apparatus 2 includes an angular velocity sensor 90. In the exemplary embodiment, the angular velocity sensor 90 detects angular velocities about predetermined three axes (e.g., the xyz axes shown in FIG. 1). It should be noted that the angular velocity sensor 90 may detect an angular velocity about one axis or angular velocities about two axes.

The acceleration sensor 89 and the angular velocity sensor 90 are connected to the processor 81, and the detection results of the acceleration sensor 89 and the angular velocity sensor 90 are output to the processor 81. Based on the detection results of the acceleration sensor 89 and the angular velocity sensor 90, the processor 81 can calculate information regarding the motion and/or the orientation of the main body apparatus 2.

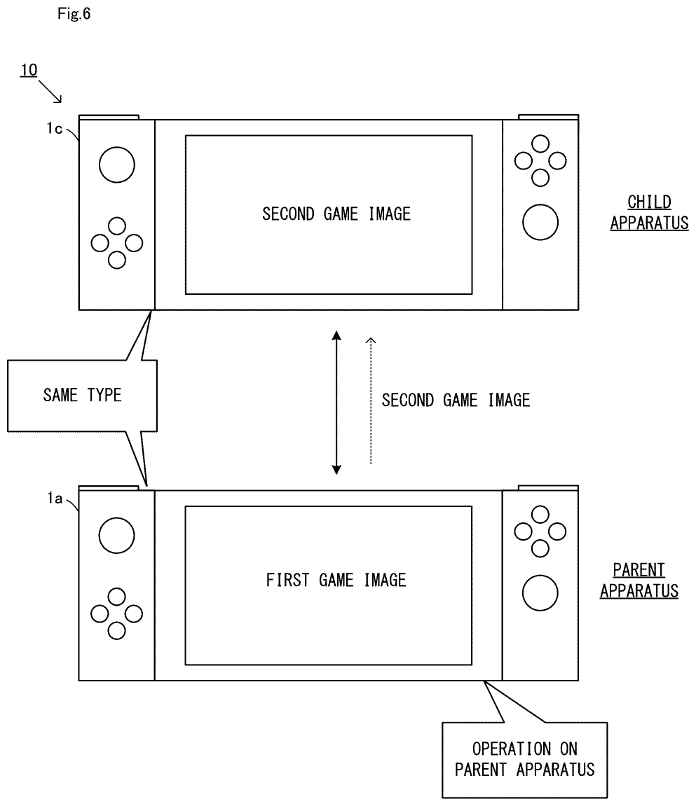

The main body apparatus 2 includes a power button 24, a power control section 97, and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 20, and the right terminal 21). Based on a command from the processor 81, the power control section 97 controls the supply of power from the battery 98 to the above components.

Further, the battery 98 is connected to the lower terminal 27. When an external charging device (e.g., the cradle 6) is connected to the lower terminal 27, and power is supplied to the main body apparatus 2 via the lower terminal 27, the battery 98 is charged with the supplied power.

The left controller 3 includes a terminal 35 that is connected to the left terminal 20 of the main body apparatus 2. The left controller 3 also includes a control section 30. The control section 30 is connected to components including the terminal 35. The control section 30 controls the method for communication performed by the left controller 3 with the main body apparatus 2. In the exemplary embodiment, the control section 30 can communicate with the main body apparatus 2 through both wired communication via the terminal 35 and wireless communication via an antenna (not shown). That is, when the left controller 3 is attached to the main body apparatus 2, the control section 30 communicates with the main body apparatus 2 via the terminal 35. Further, when the left controller 3 is detached from the main body apparatus 2, the control section 30 wirelessly communicates with the main body apparatus 2 (specifically, the controller communication section 83). The wireless communication between the controller communication section 83 and the control section 30 is performed in accordance with the Bluetooth (registered trademark) standard, for example.

Further, the left controller 3 includes a memory 33 such as a flash memory. The control section 30 includes, for example, a microcomputer (or a microprocessor) and executes firmware stored in the memory 33, thereby performing various processes.

The left controller 3 includes the analog stick (“stick” in FIG. 3) 31 and the plurality of operation buttons 32. Information regarding an operation performed on each of the analog stick 31 and the plurality of operation buttons 32 is output to the control section 30 repeatedly at appropriate timing.

Further, the left controller 3 includes a sensor 34. The sensor 34 includes an acceleration sensor and an angular velocity sensor. The acceleration sensor detects the magnitudes of accelerations along the xyz axis directions shown in FIG. 1, and the angular velocity sensor detects angular velocities about the xyz axes. The detection results of the acceleration sensor and the angular velocity sensor are output to the control section 30 repeatedly at appropriate timing.

The control section 30 acquires information regarding an input (specifically, information regarding an operation on each of the analog stick 31 and the operation buttons 32 or the detection result of the sensor 34) from each of the operation buttons 32, the analog stick 31, and the sensor 34. The control section 30 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can determine operations on the analog stick 31 and the operation buttons 32 based on the operation data. Further, based on the detection result of the sensor 34, the main body apparatus 2 can acquire information regarding the motion and/or the orientation of the left controller 3.

Although not shown in the figures, the left controller 3 includes a battery that supplies power to the above components. The left controller 3 may also include a vibrator.

As shown in FIG. 3, the right controller 4 includes a terminal 45 that is connected to the right terminal 21 of the main body apparatus 2, a control section 40, a memory 43, a stick 41, a plurality of operation buttons 42, and a sensor 44. These components have functions similar to those of the above components of the left controller 3, and therefore are not described.

### Description of Game System Including Plurality of Information Processing Apparatuses

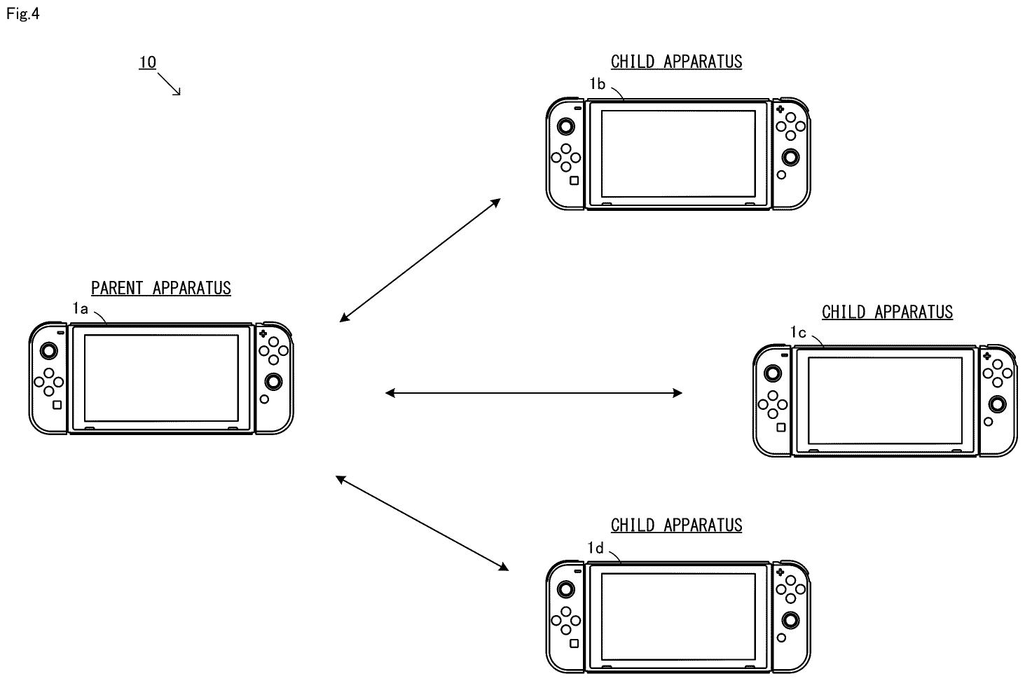

A description is given below of an example of a game system 10 for performing a game according to the exemplary embodiment described below. The game system 10 is a system configured by a plurality of information processing apparatuses 1 communicating with each other. FIG. 4 is a diagram showing an example of the game system 10 and is a diagram showing an overview of the game system 10 configured by the plurality of information processing apparatuses 1 performing the local communication with each other. FIG. 5 is a diagram showing an example of the game system 10 and is a diagram showing an overview of the game system 10 configured by the plurality of information processing apparatuses 1 performing the Internet communication with each other.

As shown in FIGS. 4 and 5, the game system 10 includes a plurality of information processing apparatuses 1. For example, the game system 10 includes an information processing apparatus 1a, an information processing apparatus 1b, an information processing apparatus 1c, and an information processing apparatus 1d.

Although FIGS. 4 and 5 exemplify cases where the game system 10 includes four information processing apparatuses 1, the number of information processing apparatuses 1 included in the game system 10 may be optional. In both the communication forms shown in FIGS. 4 and 5, the plurality of information processing apparatuses 1 included in the game system 10 may operate in the mobile mode, or may operate in the stationary mode, or may operate in the table mode, or these modes may coexist. For example, in the communication form shown in FIG. 4, all the information processing apparatuses 1a to 1d may operate in the mobile mode, or may operate in the stationary mode, or may operate in the table mode, or the mobile mode, the stationary mode, and the table mode may coexist. Although in the game system 10 shown in FIG. 5, information processing apparatuses in the stationary mode (1a and 1b) and information processing apparatuses in the mobile mode (1c and 1d) coexist, an information processing apparatus in the table mode may be included, or all the information processing apparatuses 1a to 1d may operate in the mobile mode, or may operate in the stationary mode, or may operate in the table mode.

In FIGS. 4 and 5, the information processing apparatus 1a functions as a parent apparatus. The information processing apparatus 1a as the parent apparatus executes a game program. The processor 81 of the information processing apparatus 1a executes the game program, thereby executing game processing regarding a predetermined game. For example, an external storage medium that stores the game program can be attached to the slot 23 of the information processing apparatus 1a, and the processor 81 of the information processing apparatus 1a can read the game program stored in the external storage medium into the DRAM 85 and execute the game program. The game program may be stored in the flash memory 84 of the information processing apparatus 1a, or may be stored in another storage device that can be read by the information processing apparatus 1a. The predetermined game may be any game such as a racing game, a card game, a table game, a sport game, a fighting game, a shooting game, a role-playing game, a music game, or the like.

On the other hand, in FIGS. 4 and 5, the information processing apparatuses 1b to 1d function as child apparatuses. Each of the information processing apparatuses 1b to 1d as the child apparatuses may not store the game program for executing the predetermined game and not be able to execute the game program. That is, an external storage medium that stores the game program is not attached to the slot 23 of the child apparatus, and the game program is not stored in the flash memory 84 of the child apparatus, either.

Each child apparatus may also store the game program, but any one of the plurality of information processing apparatuses 1 may function as a parent apparatus, the remaining information processing apparatuses 1 may function as child apparatuses, and only the parent apparatus may execute game processing.

A plurality of child apparatuses may include an apparatus that only functions as a child apparatus.

A parent apparatus and child apparatuses may be information processing apparatuses of same type (e.g., game apparatuses of the same type). A parent apparatus and child apparatuses may be information processing apparatuses of different types. A plurality of child apparatuses may include an information processing apparatus of the same type as a parent apparatus and an information processing apparatus of a different type from the parent apparatus.

As shown in FIG. 4, a parent apparatus and child apparatuses may directly communicate with each other through local communication (e.g., a communication method based on a unique protocol or a method compliant with the Wi-Fi standard). As shown in FIG. 5, a parent apparatus and child apparatuses may communicate with each other via the Internet 8. In the exemplary embodiment, a predetermined game is executed using a parent apparatus and child apparatuses. The parent apparatus and the child apparatuses establish connections with each other before the predetermined game starts.

Specifically, a parent apparatus acquires operation data relating to an operation on the controller (the first controller or the second controller) of the parent apparatus. Here, the operation data relating to an operation on the controller of the parent apparatus is referred to as “parent apparatus operation data”. A child apparatus transmits operation data relating to an operation on the controller (the first controller or the second controller) of the child apparatus to the parent apparatus. Here, the operation data transmitted from the child apparatus to the parent apparatus is referred to as “child apparatus operation data”.

The parent apparatus performs game processing based on the parent apparatus operation data. The parent apparatus also receives the child apparatus operation data transmitted from the child apparatus and performs game processing based on the child apparatus operation data. The content of the game processing differs depending on the type of the game.

Next, the parent apparatus generates image data based on the result of the game processing. Specifically, the parent apparatus generates parent apparatus image data and child apparatus image data.

The parent apparatus outputs the generated parent apparatus image data to the display 12 or the stationary monitor 5. Consequently, a parent apparatus game image is displayed on the display 12 or the stationary monitor 5 of the parent apparatus. The parent apparatus also transmits the generated child apparatus image data to the child apparatus. The child apparatus receives the child apparatus image data transmitted from the parent apparatus and outputs the child apparatus image data to the display 12 or the stationary monitor 5. Consequently, a child apparatus game image is displayed on the display 12 or the stationary monitor 5 of the child apparatus. The parent apparatus may generate parent apparatus sound data and output a sound based on the sound data. The parent apparatus may also generate child apparatus sound data and transmit the child apparatus sound data to the child apparatus, and the child apparatus may output a sound based on the child apparatus sound data.

As described above, the game system 10 for performing the game according to the exemplary embodiment includes a plurality of information processing apparatuses 1, any one of the plurality of information processing apparatuses 1 functions as a parent apparatus, and the other information processing apparatuses 1 function as child apparatuses. Game processing is performed based on parent apparatus operation data relating to an operation performed on the parent apparatus. Child apparatus operation data relating to an operation performed on each child apparatus is transmitted from the child apparatus to the parent apparatus, and game processing based on the child apparatus operation data is performed by the parent apparatus. The parent apparatus generates a game image relating to the result of the game processing and displays the game image on the display 12 or the stationary monitor 5 of the parent apparatus. The parent apparatus also transmits a game image relating to the result of the game processing to the child apparatus, and the game image is displayed by the child apparatus. Consequently, a game is performed in the game system 10 including the parent apparatus and the child apparatuses.

Next, a description is given of the game according to the exemplary embodiment performed using the game system 10 as described above.

### Illustration of Game Performed in Game System

An example of a case where a two-screen game is executed in the game system 10 will be described. Here, a two-screen game is a game that uses two screens (e.g., a game that generates game images to be displayed on two different display devices). That is, the game program for executing the game includes instructions for generating two game images to be displayed on two different display devices. Note however that it is not necessary for game images to be displayed on both screens at all times during the game, and in certain situations during the game (e.g., when a predetermined movie is being played), images may be displayed on only one screen, with no image displayed on the other screen. In certain situations during the game, the images displayed on the two screens may be the same.

### First Example

FIG. 6 is a diagram showing an example of the game system 10 in the first example. In the first example, the game system 10 includes two information processing apparatuses 1a and 1c of the same type. That is, the information processing apparatuses 1a and 1c are both of the type of information processing apparatus capable of executing the game program of the two-screen game. Note that “an information processing apparatus being capable of executing a game program” means that the information processing apparatus is capable of executing the game program in some way, and includes cases where the game program is compatible with the information processing apparatus, as well as cases where the information processing apparatus has an emulator and executes the game program using the emulator.

Note that, in the first to third examples described below, communication between the information processing apparatuses in the game system 10 is performed by the local communication described above. Note however that communication between the information processing apparatuses may be performed by the Internet communication described above.

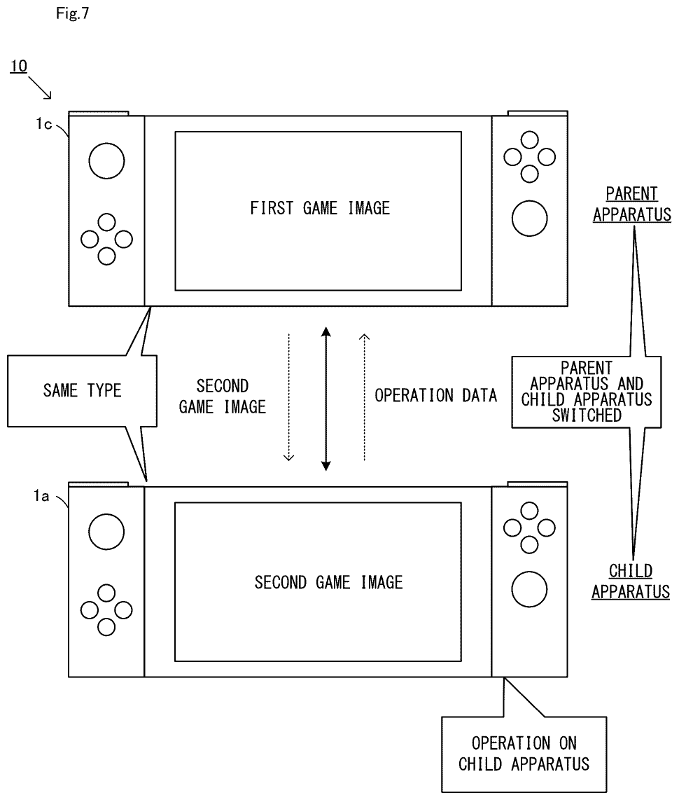

In FIG. 6, the information processing apparatus 1a operates as a parent apparatus (e.g., the information processing apparatus 1a executes the game program), and game operations are performed using the parent apparatus. Note that, as will be described in more detail later, in the first example, the game system 10 may also be configured so that the information processing apparatus 1a operates as a child apparatus (e.g., the information processing apparatus 1c executes the game program), and game operations are performed using the child apparatus (see FIG. 7). In the following, the state of the game system 10 performing the former operation will be referred to as the first mode, and the state of the game system 10 performing the latter operation will be referred to as the second mode. FIG. 6 shows the data exchange between apparatuses when the game system 10 operates in the first mode.

In the first mode, the game system 10 accepts a user input on the information processing apparatus 1a, which is the parent apparatus. Note that “accepting an input on an information processing apparatus” means accepting an input to the controller (e.g., the first controller or the second controller described above) of this information processing apparatus, and/or to this information processing apparatus itself (e.g., an input to a button or the touch panel of the information processing apparatus, or an input of moving the information processing apparatus itself). That is, the user performs game operations using the information processing apparatus 1a itself or the controller of the information processing apparatus 1a.

The information processing apparatus 1a executes the game process based on a user input by executing the game program. Note that this game process may be any process for advancing the game, and differs depending on the game content. The information processing apparatus 1a generates two types of game images based on the results of the game process. In the following, the game image displayed on the information processing apparatus (here, the information processing apparatus 1a) that accepts a user input is referred to as the first game image, and the game image displayed on the other information processing apparatus is referred to as the second game image. The first game image and the second game image are different images from each other.

The specific content of each game image is arbitrary. For example, if the game accepts inputs to the touch panel, the first game image may include UI (user interface) images associated with touch inputs. Since this is an image displayed on the information processing apparatus on which game operations are performed, the above makes it easier for the user to perform game operations. Note that the UI images include, for example, images of buttons that represent instructions by touch input, menu images or map images on which touch inputs can be made. The second game image may be, for example, an image that represents the game space. The first and second game images may be game images that show the game space from different perspectives.

In the information processing apparatus 1a, a first frame buffer for the first game image and a second frame buffer for the second game image are prepared. The first game image is stored in the first frame buffer each time it is generated, and the second game image is stored in the second frame buffer each time it is generated.

In the example shown in FIG. 6, the information processing apparatus 1a, which is the parent apparatus, transmits the second game image stored in the second frame buffer to the information processing apparatus 1c, which is the child apparatus. The information processing apparatus 1c displays the received second game image. In the first example, the game system 10 advances the game by repeating the operation of accepting inputs, performing the game process, and generating game image generation described above. Note that each of the information processing apparatuses 1a and 1c may display the second game image on the display 12 thereof, or may display the second game image on the stationary monitor 5 connected thereto. For example, a user may connect the information processing apparatus associated with the game image that the user wishes to display on a large screen to the stationary monitor so that one game image is displayed on a large screen while the other game image is displayed on the information processing apparatus at hand.

Note that in the example shown in FIG. 6, the information processing apparatus 1c does not need to store the game program described above. That is, in order to execute the two-screen game described above, it is sufficient for the game program to be stored in the information processing apparatus 1a, and then, the user can play the two-screen game using the two information processing apparatuses in such a manner as shown in FIG. 6.

Note that, in the first example, if the above game program is stored in the information processing apparatus 1c, the game system 10 can also operate in the second mode in which the information processing apparatus 1c operates as the parent apparatus. FIG. 7 is a diagram showing an example of the game system 10 when operating in the second mode. FIG. 7 shows a case in which the mode is switched from the first mode shown in FIG. 6 to the second mode, resulting the switching between the parent apparatus and the child apparatus (e.g., the information processing apparatus 1a becomes the child apparatus and the information processing apparatus 1c becomes the parent apparatus).

As described above, in the second mode, game operations are performed using the information processing apparatus that is operating as a child apparatus. That is, in the second mode, the game system 10 accepts a user input on the information processing apparatus 1a, which is the child apparatus. The information processing apparatus 1a transmits operation data based on the user input to the information processing apparatus 1c, which is the parent apparatus (see FIG. 7). The information processing apparatus 1c executes the game process based on the received operation data, and generates the first and second game images based on the results of the game process, and stores the game images in the first and second frame buffers, respectively. Then, the information processing apparatus 1c displays the first game image on the display 12 thereof (or on the stationary monitor 5 connected thereto), and transmits the second game image to the information processing apparatus 1a (see FIG. 7). The information processing apparatus 1a displays the received second game image on the display 12 thereof (or on the stationary monitor 5 connected thereto). Thus, in the second mode, the second game image is displayed on the information processing apparatus that is operated by the user (here, the information processing apparatus 1a). Note that, in other embodiments, the first game image may be displayed on the information processing apparatus that is operated by the user in the second mode.

In the first example, the first mode and the second mode may be switched at any time. For example, the switching between the first mode and the second mode may be done during the game. For example, the game system 10 accepts a switching instruction from the user to switch the mode during the game. In the first example, the input for the switching instruction may be accepted by any one of the two information processing apparatuses, or, both of or either one of the two information processing apparatuses. For example, by making it possible to accept the switching instruction by both of the two information processing apparatuses, it is possible to improve the convenience for the user.

For example, the information processing apparatus may pause the game during the game, and display a menu screen of the information processing apparatus. At this time, the input for the switching instruction may be accepted on the menu screen. For example, the switching instruction may be given by an input to a predetermined button during the game. The game system 10 may accept the switching instruction not only during the game but also when the game is not being executed.

In response to a switching instruction given by the user, the information processing apparatus that is the parent apparatus generates execution status data that indicates the current execution status of the game program. The execution status data indicates various information used to start the game by the game process on the connection partner information processing apparatus in the same status as the game status at the time of the switching instruction being given. For example, the execution status data may include data indicating the game status at the time of the switching instruction being given (e.g., the state of each object in the game space, etc.), or may include data indicating the information stored in the memory of the parent apparatus at that time. For example, if the game program has the function of generating save data, the execution status data may include save data generated at that time.

Note that, in the first example, the parent apparatus generates the execution status data while the game is paused. For example, if the switching instruction is accepted on the menu screen described above, the parent apparatus generates the execution status data while maintaining the state in which the game is paused when the menu screen is displayed. For example, if the switching instruction is given by an input to a predetermined button during the game, the parent apparatus generates the execution status data after pausing the game in response to the switching instruction. This prevents the game from continuing to progress during the mode switching process. Note that “pausing the game” as used in the above description means temporarily pausing the progress of the game, and the execution of the game program itself may or may not be stopped.

The parent apparatus transmits the generated execution status data to the information processing apparatus that is the child apparatus. The child apparatus, which has received the execution status data, becomes the parent apparatus and resumes the game based on the execution status data. This allows the game to be resumed in the same status as the game status at the time of the switching instruction being given. After the game is resumed, the processing to advance the game is executed in the second mode described above.

As described above, in the first example, the user can play a two-screen game by using two information processing apparatuses. In the first example, the user can perform game operations on either one of the two information processing apparatuses, and it is therefore possible to improve the convenience for the user.

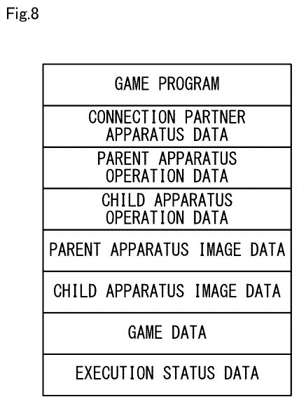

Next, the details of the processes performed by the game system 10 in the first example will be described. First, the data stored in the information processing apparatuses 1a and 1c will be described. FIG. 8 is a diagram showing an example of data stored in the information processing apparatuses 1a and 1c. The data shown in FIG. 8 is stored in the memory (an external storage medium, a flash memory 26, or the DRAM 85) of the main body apparatus 2.

As shown in FIG. 8, the information processing apparatuses 1a and 1c store the game program, the connection partner apparatus data, the parent apparatus operation data, the child apparatus operation data, the parent apparatus image data, the child apparatus image data, the game data, and the execution status data.

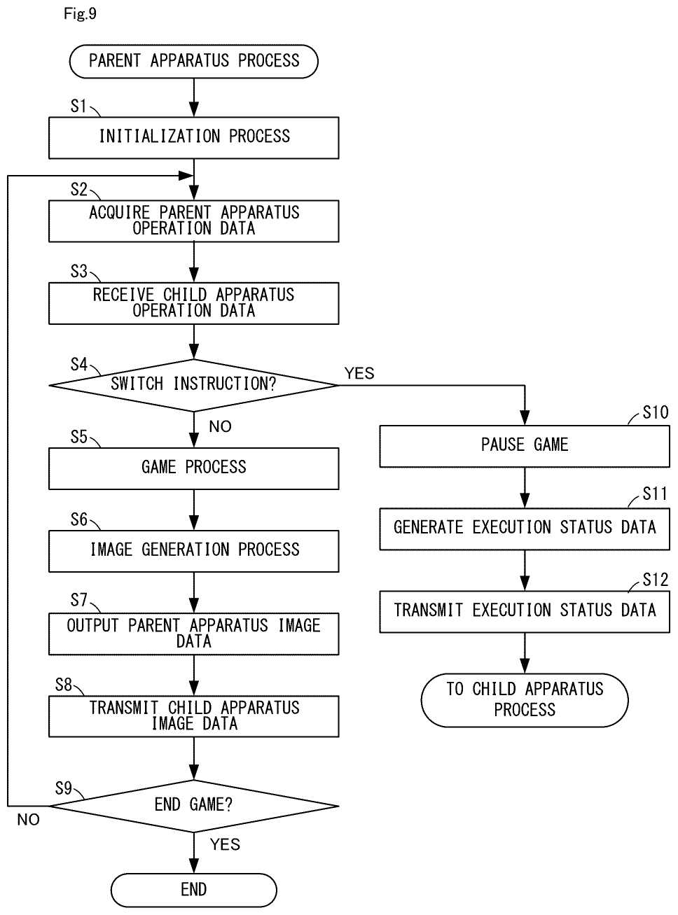

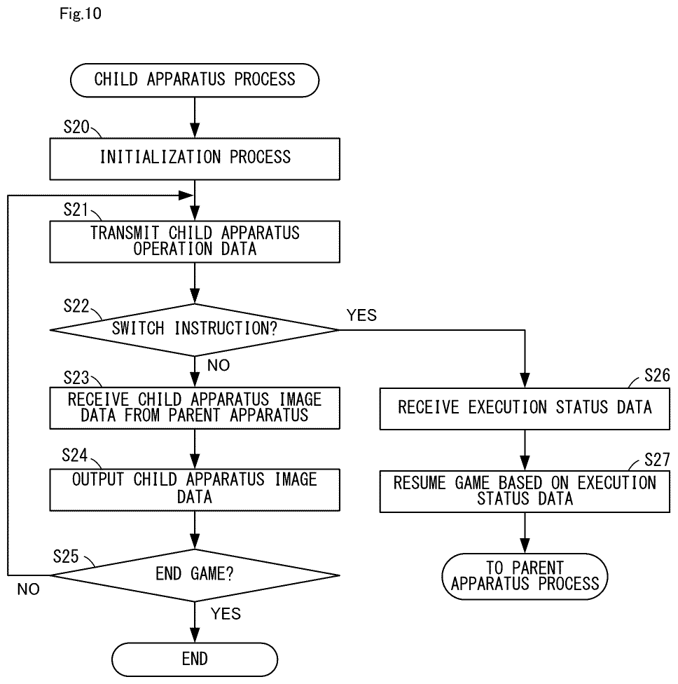

The game program is a program for executing the two-screen game described above, and is a program for executing the parent apparatus process (FIG. 9) to be described below. Note that, although not shown in FIG. 8, the information processing apparatuses 1a and 1c store a program for executing the child apparatus process (FIG. 10) that is executed when operating as a child apparatus, and for participating in the game that is executed by the parent apparatus. This program may be stored in advance in the information processing apparatus, or it may be transmitted from the parent apparatus to the child apparatus at the start of the game program.

The connection partner apparatus data is data related to an information processing apparatus that is connected, as a communication partner, to the subject apparatus (e.g., the information processing apparatus that stores the connection partner apparatus data). For example, the connection partner apparatus data includes information that specifies the connection partner apparatus (e.g., the device ID or the MAC address, etc.).

The parent apparatus operation data is data representing operations performed on the controller (e.g., the first controller or the second controller) of the parent apparatus. The main body apparatus 2 acquires the parent apparatus operation data from the controllers thereof at a predetermined time interval (e.g., at intervals of 1/200 second). Note that the parent apparatus operation data may also include data representing touch operations on the touch panel 13 of the main body apparatus 2.

The child apparatus operation data is data representing operations performed on the controller of the child apparatus (e.g., the first controller or the second controller), and is transmitted from the child apparatus to the parent apparatus. Note that the child apparatus operation data may include data representing touch operations on the touch panel 13 of the main body apparatus 2. Here, the child apparatus transmits the child apparatus operation data at a predetermined time interval (e.g., at intervals of 1/60 second).

The parent apparatus image data is image data that indicates the game image displayed on the parent apparatus, and is generated on the parent apparatus. The child apparatus image data is image data that indicates the game image displayed on the child apparatus, and is generated on the parent apparatus. In the first example, the parent apparatus image data is the data of the first game image, and the child apparatus image data is the data of the second game image. Note that when the child apparatus image data is transmitted to another information processing apparatus, the size of the image data (e.g., the resolution) may be variable. In addition, the image size of the parent apparatus image data and the image size of the child apparatus image data may be the same or different.

The game data is data that indicates the results of the game process based on a user input. For example, game data may be data that indicates the status of each object in the game space, etc.

FIG. 9 is a flowchart showing an example of the flow of the parent apparatus process in the first example. The parent apparatus process is executed in the information processing apparatus that operates as the parent apparatus in the first example (e.g., the information processing apparatus 1a in the first mode and the information processing apparatus 1c in the second mode). The parent apparatus process is started, for example, in response to the game program being started and the game being started.

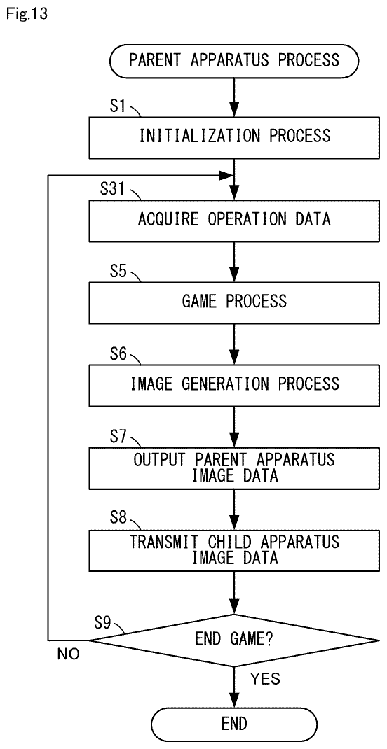

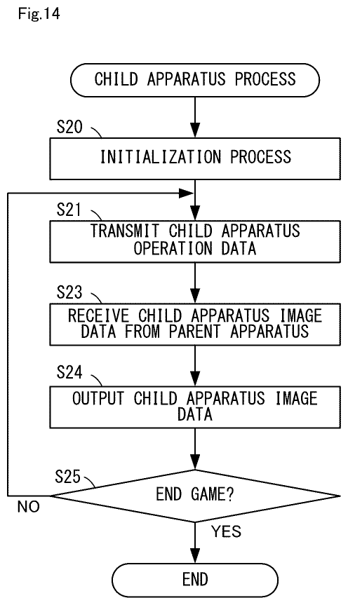

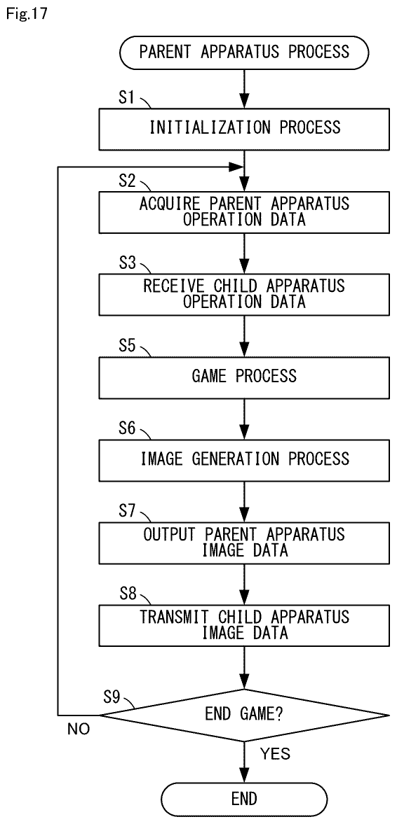

Note that, in the exemplary embodiment, the processor 81 of the main body apparatus 2 executes the game program stored in the game system 10 to execute processes of the steps shown in FIG. 9, FIG. 10, FIG. 13, FIG. 14, and FIG. 17. Note however that in other embodiments, some of the processes of these steps may be executed by a processor (e.g., a dedicated circuit) other than the processor 81. In addition, where the game system 10 is capable of communicating with another information processing apparatus (e.g., a server), some of the processes of the steps may be executed in the other information processing apparatus. Furthermore, the processes of the steps are merely illustrative, and the order of steps to be performed may be switched around or other processes may be executed in addition to (or instead of) the processes of the steps, as long as substantially the same results are obtained.

The processor 81 executes the processes of the steps using a memory (e.g., the DRAM 85). That is, the processor 81 stores information (in other words, data) obtained by the process steps in the memory, and reads out the information from the memory to use the information in a subsequent process step.

As shown in FIG. 9, the processor 81 first performs the initialization process (step S1). The initialization process includes, for example, the process of setting the subject apparatus (e.g., the information processing apparatus that includes the processor 81) as the parent apparatus, the process of establishing communication between the subject apparatus and the child apparatus, the process of transmitting a notification to the child apparatus that the game is to be started, and the process of preparing for the execution of a subsequent process (e.g., the process of setting a frame buffer in the memory). Note that the specific content of the initialization process is arbitrary, and in addition to the above, the process of selecting the mode of communication (local communication or the Internet communication) may be executed. The mode of communication that can be selected by the user varies depending on the game being executed. When the initialization process is complete, the processor 81 starts the game, and thereafter, while the subject apparatus is operating as the parent apparatus, the processes of steps S2 to S9 are repeatedly executed at a predetermined time interval (e.g., at intervals of 1/60 second).

Following step S1, the processor 81 acquires the parent apparatus operation data (step S2). Specifically, when the information processing apparatus that is the parent apparatus operates in the mobile mode, the processor 81 acquires the parent apparatus operation data from the first controller (e.g., the left controller 3 and the right controller 4) attached to this information processing apparatus. In addition, when the information processing apparatus that is the parent apparatus operates in the stationary mode or the table mode, the processor 81 acquires the parent apparatus operation data from the first controller or the second controller that is wirelessly connected to this information processing apparatus.

Following step S2, the processor 81 receives the child apparatus operation data from the child apparatus using the network communication section 82 (step S3).

Following step S3, the processor 81 determines whether or not a switching instruction has been given by the user (step S4). That is, the processor 81 determines whether or not a switching instruction has been given based on the parent apparatus operation data or the child apparatus operation data. If the determination result from step S4 is YES, the process of step S10 to be described below is executed.

On the other hand, if the determination result from step S4 is NO, the processor 81 performs the game process based on the parent apparatus operation data or the child apparatus operation data (step S5). That is, game data indicating the results of the game process is generated and stored in the memory. In the first example, the game process is performed based on the parent apparatus operation data in the first mode, and the game process is performed based on the child apparatus operation data in the second mode. The specific details of the game process are arbitrary and, for example, the game process includes the process of controlling the player character based on the parent apparatus operation data, the process of controlling characters other than the player character in accordance with a predetermined algorithm, and the process of changing the parameters set for each object (including the player character and other characters).

Next, the processor 81 performs the image generation process (step S6) based on the results of the game process (in other words, based on the game data). Specifically, the processor 81 generates the parent apparatus image data and the child apparatus image data. In the exemplary embodiment, the first frame buffer for storing the first image data and the second frame buffer for storing the second image data are prepared in advance (e.g., before the start of the game) in the memory. The processor 81 updates each frame buffer every time each image data is generated. Note that, in step S6, the processor 81 may generate audio data for the parent apparatus and audio data for the child apparatus.

Next, the processor 81 outputs the parent apparatus image data generated in step S6 to the display 12 or the stationary monitor 5 (step S7). In addition, the parent apparatus causes the audio based on the audio data for the parent apparatus generated in step S6 to be output from the speaker 88 or the speaker of the stationary monitor 5.

Next, the processor 81 transmits the second image data generated in step S6 to the child apparatus (step S8). Specifically, the network communication section 82 transmits the second image data stored in the second frame buffer to the child apparatus based on an instruction from the processor 81. The network communication section 82 also transmits the audio data to the child apparatus based on an instruction from the processor 81.

Next, the processor 81 determines whether or not to end the game (step S9). The processor 81 gives a determination result of YES in step S9, for example, if the game is completed or if the user gives an instruction during the game to forcibly end the game. If the determination result from step S9 is YES, the processor 81 ends the game and transmits a game end notification to the child apparatus. On the other hand, if the determination result from step S9 is NO, the processor 81 executes the process of step S2 again.

On the other hand, if the determination result from step S4 is YES, the processor 81 pauses the game (step S10). At this time, the processor 81 transmits a notice to the child apparatus that a switching instruction has been given or that the game has been paused. Next, the processor 81 generates execution status data based on the current game status and/or based on the information currently stored in the memory (step S11). Next, the processor 81 uses the network communication section 82 to transmit the generated execution status data to the child apparatus (step S12). As will be explained in more detail later, after this, the information processing apparatus that has been a child apparatus becomes a parent apparatus and the game is resumed (see FIG. 10). After the process of step S12, the processor 81 ends the parent apparatus process shown in FIG. 9, and starts executing the child apparatus process shown in FIG. 10 in order to operate as a child apparatus. This completes the explanation of the parent apparatus process shown in FIG. 9.

FIG. 10 is a flowchart showing an example of the flow of the child apparatus process in the first example. The child apparatus process is executed in the information processing apparatus that operates as a child apparatus in the first example (e.g., the information processing apparatus 1c in the first mode and the information processing apparatus 1a in the second mode). The child apparatus process is started in response to the establishment of communication with the parent apparatus, for example.

As shown in FIG. 10, the processor 81 first performs the initialization process (step S20). In the initialization process, the process of setting the subject apparatus (e.g., the information processing apparatus that includes the processor 81) as a child apparatus, and the process of preparing to execute a subsequent process (e.g., the process of setting the frame buffer in the memory) are performed. Note that when the game is started on the parent apparatus, the initialization process is completed on the child apparatus. Thereafter, while the subject apparatus is operating as a child apparatus, the processor 81 repeatedly executes the processes of step S21 to step S25 at a predetermined time interval (e.g., at intervals of 1/60 second).

When the game is started, the processor 81 transmits the child apparatus operation data to the parent apparatus (step S21). Specifically, when the information processing apparatus that is a child apparatus is operating in the mobile mode, the processor 81 acquires the operation data from the first controller (e.g., the left controller 3 and the right controller 4) attached to the information processing apparatus. Also, when the information processing apparatus that is a child apparatus is operating in the stationary mode or the table mode, the processor 81 acquires the operation data from the first controller or the second controller wirelessly connected to the information processing apparatus. The operation data acquired is transmitted, as the child apparatus operation data, to the parent apparatus by the network communication section 82. Note that the operation data output from the controller of the child apparatus may be transmitted, as is, to the parent apparatus as the child apparatus operation data, or the data obtained by performing a predetermined process on the operation data output from the controller of the child apparatus may transmitted to the parent apparatus as the child apparatus operation data.

Following step S21, the processor 81 determines whether or not a switching instruction has been given by the user (step S22). This determination is made, for example, by determining whether or not a notification has been received from the parent apparatus to the effect that a switching instruction has been given or that the game has been paused. Note that, where the child apparatus also accepts a switching instruction, the processor 81 may determine whether or not a switching instruction has been given by an input to the subject apparatus (e.g., the information processing apparatus that includes the processor 81). If the determination result from step S22 is YES, the process of step S26 to be described later is executed.

Following step S22, the processor 81 receives the child apparatus image data from the parent apparatus (step S23). At this time, the child apparatus may receive the audio data for the child apparatus from the parent apparatus.

On the other hand, if the determination result from step S22 is NO, the processor 81 outputs the child apparatus image data received from the parent apparatus to the display 12 or the stationary monitor 5 (step S24). Note that the processor 81 may output the audio based on the audio data received from the parent apparatus.

Next, the processor 81 determines whether or not to end the game (step S25). For example, if the child apparatus receives a game end notification from the parent apparatus or if an instruction is given during the game to forcibly end the game, the game is ended and the child apparatus process shown in FIG. 10 is ended. On the other hand, if the game is not to be ended, the processor 81 executes the process of step S21 again.

On the other hand, if the determination result from step $22, the processor 81 receives the execution status data from the parent apparatus (step S26). Then, the processor 81 resumes the game based on the received execution status data (step S27). For example, the game is resumed with the game status indicated by the execution status data, or the game is resumed using information stored in the memory indicated by the execution status data. After the process of step S27, the processor 81 ends the child apparatus process shown in FIG. 10, and starts executing the parent apparatus process shown in FIG. 9 in order to operate as a parent apparatus. This completes the explanation of the child apparatus process shown in FIG. 10.

As described above, in the first example, an information processing system (e.g., the game system 10) causes a processor of a game apparatus to execute a game program for performing a game process based on operation data to generate a first game image to be displayed on a first screen and a second game image to be displayed on a second screen. A first game apparatus (e.g., the information processing apparatus 1a) and a second game apparatus (e.g., the information processing apparatus 1c) included in the information processing system each include at least one processor and are each configured to:
acquire input data based on an input to at least one of a controller device that is provided in the game apparatus (e.g., the first controller) and a controller device that is connected to the game apparatus (e.g., the second controller); and
output an image to one of a display device that is provided in the game apparatus (e.g., the display 12) and a display device that is connected to the game apparatus (e.g., the stationary monitor 5).

The first information processing apparatus and the second information processing apparatus communicate with each other. In the first mode, the processor of the first information processing apparatus is configured to:
acquire first input data based on an input to one of the controller device that is provided in the first information processing apparatus or the controller device that is connected to the first information processing apparatus (step S2);
execute the game program using the first input data as the operation data (step S5);
store a first image and a second image in a frame buffer (step S6);
output the first image stored in the frame buffer to one of the display devices (step S7); and
transmit the second image stored in the frame buffer to the second information processing apparatus (step S8).

In the first mode, the processor of the second information processing apparatus is configured to:
output the second image received from the first information processing apparatus to one of the display devices (step S24).

According to the above, the user can play a game in a novel way such that a two-screen game is played using two information processing apparatuses.

In the first example, in the second mode, the processor of the second information processing apparatus is configured to:
execute the game program using the first input data received from the first information processing apparatus as the operation data (step S3);
store the first image and the second image in the frame buffer (step S6);
output the first image stored in the frame buffer to one of the display devices (step S7); and
transmit the second image stored in the frame buffer to the first information processing apparatus (step S8).

In the second mode, the processor of the first information processing apparatus is configured to:
transmit the first input data to the second information processing apparatus (step S21); and
output the second image received from the second information processing apparatus to one of the display devices (step S24).

According to the above, the user can perform game operations on either of the two information processing apparatuses, and it is therefore possible to improve the convenience for the user.

In the first example, the information processing system switches between the first mode and the second mode by a predetermined instruction input (e.g., an input for a switching instruction). When transitioning from the first mode to the second mode, the processor of the first information processing apparatus transmits execution status data that indicates an execution status of the game program to the second information processing apparatus (step S12), and the processor of the second information processing apparatus resumes execution of the game program based on the received execution status data (step S26). When transitioning from the second mode to the first mode, the processor of the second information processing apparatus transmits the execution status data to the first information processing apparatus (step S12), and the processor of the first information processing apparatus resumes execution of the game program based on the received execution status data (step S27).

According to the above, the user can switch the information processing apparatus on which game operations are performed, and it is therefore possible to improve the convenience for the user.

### Second Example

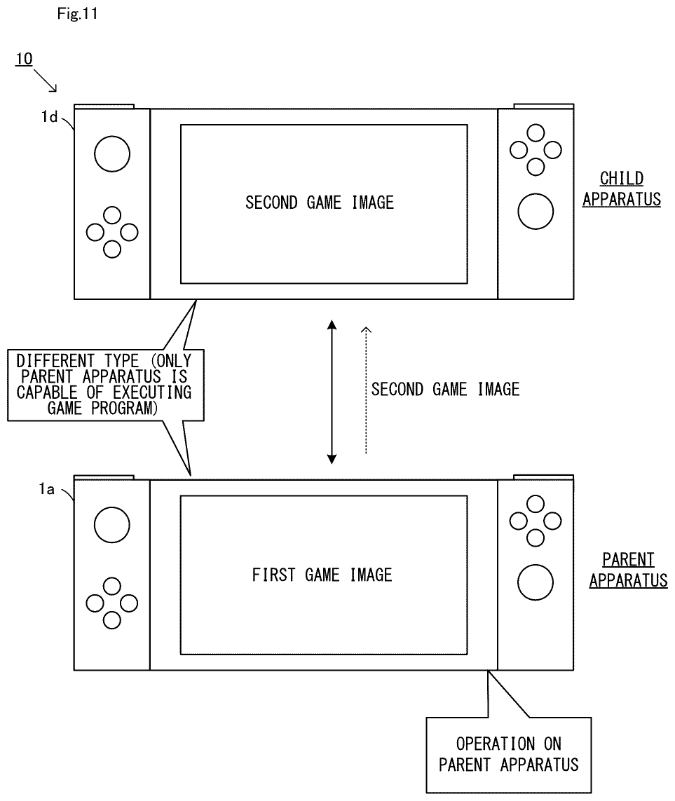

FIG. 11 is a diagram showing an example of the game system 10 in the second example. In the second example, a two-screen game similar to the first example is executed in the game system 10 that includes the two information processing apparatuses 1a and 1d of different types. In the second example, the information processing apparatus 1a is capable of executing the game program of the two-screen game, whereas the information processing apparatus 1d is not capable of executing the game program of the two-screen game. For example, the information processing apparatus 1a and the information processing apparatus 1d may not be mutually compatible, or only one of them may be compatible with the other (e.g., one information processing apparatus being capable of executing a game program compatible with the other information processing apparatus). In the second example, the information processing apparatus 1d is not limited to the information processing apparatus including the main body apparatus 2 and the left and right controllers 3 and 4, but may be an information processing apparatus such as a smartphone, for example.

FIG. 11 shows an example of a case where the user performs game operations using the information processing apparatus 1a to be the parent apparatus. In this case, the information processing apparatus 1a operates in the same way as the information processing apparatus 1a in the first mode of the first example, and the information processing apparatus 1d operates in the same way as the information processing apparatus 1c in the first mode of the first example.

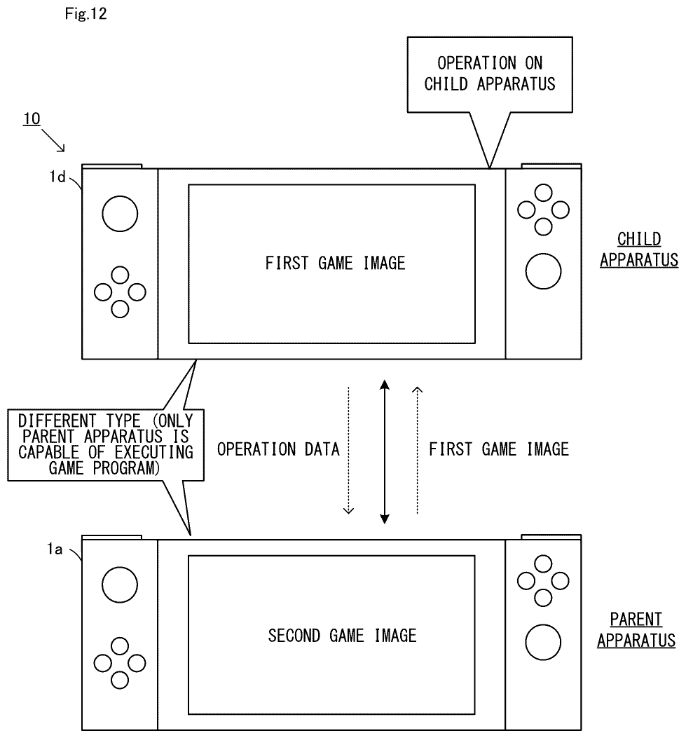

In the second example, the game system 10 can operate in the third mode in which an input to the information processing apparatus 1a is accepted (e.g., game operations are performed using the information processing apparatus 1a), and can also operate in the fourth mode in which an input to the information processing apparatus 1d is accepted (e.g., game operations are performed using the information processing apparatus 1d). FIG. 12 is a diagram showing an example of the game system 10 operating in the fourth mode in the second example.

In the fourth mode, the game system 10 accepts the user input on the information processing apparatus 1d, which is the child apparatus. The information processing apparatus 1d transmits operation data based on the user input to the information processing apparatus 1a, which is the parent apparatus (see FIG. 12). The information processing apparatus 1a executes the game process based on the received operation data, and generates the first and second game images based on the results of the game process and stores the first and second game images in the first and second frame buffers, respectively. Then, the information processing apparatus 1a displays the second game image on the display 12 thereof (or the stationary monitor 5 connected thereto), and transmits the first game image to the information processing apparatus 1d (see FIG. 12). The information processing apparatus 1d displays the received first game image on the display 12 thereof (or the stationary monitor 5 connected thereto).

Note that the fourth mode in the second example differs from the second mode in the first example (see FIG. 7), in which the second game image is displayed on the child apparatus on which game operations are performed (e.g., the information processing apparatus 1a), in that the first game image is displayed on the child apparatus on which game operations are performed (e.g., the information processing apparatus 1d). However, in other embodiments, in the fourth mode, the game system 10 may display the second game image on the child apparatus on which game operations are performed.

As described above, according to the second example, the user can play a two-screen game using two information processing apparatuses as in the first example. According to the second example, even if one of the information processing apparatuses is not capable of executing the game program, the user can perform game operations on either of the two information processing apparatuses as in the first example.

Next, the details of the processes performed by the game system 10 in the second example will be described. First, the data stored in the information processing apparatuses 1a and 1d will be described. In the second example, the information processing apparatus 1a, which is the parent apparatus, stores the game program, the connection partner apparatus data, the parent apparatus operation data, the child apparatus operation data, the parent apparatus image data, the child apparatus image data, and the game data, among the data shown in FIG. 8. The information processing apparatus 1d, which is the child apparatus, stores the connection partner apparatus data, the child apparatus operation data, and the child apparatus image data, among the data shown in FIG. 8.

FIG. 13 is a flowchart showing an example of the flow of the parent apparatus process in the second example. Note that, in the description of FIG. 13 below, like processes to those of the parent apparatus process shown in FIG. 9 will be denoted by like step numbers, and will not be described in detail.

In the parent apparatus process shown in FIG. 13, the process of step S1 is executed in the same way as the parent apparatus process shown in FIG. 9. Here, in the parent apparatus process shown in FIG. 13, the process of acquiring the operation data (step S31) is executed, following step S1. The process of step S31 is the process of acquiring the parent apparatus operation data (step S2 shown in FIG. 9) in the third mode, and is the process of acquiring the child apparatus operation data (step S3 shown in FIG. 9) in the fourth mode. Following step S31, the processes of steps S5 to S9 are executed as in the first example. Note that, in the second example, in the third mode, the first game image is output as the parent apparatus image data in step S6, and the second game image is output as the child apparatus image data in step S7. On the other hand, in the fourth mode, the second game image is output as the parent apparatus image data in step S6, and the first game image is output as the child apparatus image data in step S7.

FIG. 14 is a flowchart showing an example of the flow of the child apparatus process when operating in the fourth mode in the second example. Note that, in the description of FIG. 14 below, like processes to those of the child apparatus process shown in FIG. 10 will be denoted by like step numbers, and will not be described in detail.

In the child apparatus process shown in FIG. 14, the processes of steps S20, S21, S23, S24, and S25 are executed in the same way as the child apparatus process shown in FIG. 10. Note that, in the third mode, the child apparatus operation data is not used in the game process and, therefore, the process of step S21 does not need to be executed. Note that in steps S23 and S24 of the second example, the second game image is received and output as the child apparatus image data in the third mode, and the first game image is received and output as the child apparatus image data in the fourth mode.

As described above, in the second example, an information processing system (e.g., the game system 10) causes a processor of an information processing apparatus to execute a game program for performing a game process based on operation data to generate a first game image to be displayed on a first screen and a second game image to be displayed on a second screen. A first game apparatus (e.g., the information processing apparatus 1a) and a second game apparatus (e.g., the information processing apparatus 1d) included in the information processing system each include at least one processor and are each configured to:
acquire input data based on an input to at least one of a controller device that is provided in the game apparatus (e.g., the first controller) and a controller device that is connected to the game apparatus (e.g., the second controller); and
output an image to one of a display device that is provided in the game apparatus (e.g., the display 12) and a display device that is connected to the game apparatus (e.g., the stationary monitor 5).

The first information processing apparatus and the second information processing apparatus communicate with each other. The processor of the first information processing apparatus is configured to:
acquire second input data from the second information processing apparatus (step S31);
execute the game program using the second input data as the operation data (step S5);
store a first image and a second image in a frame buffer (step S6);
output the second image stored in the frame buffer to one of the display devices (step S7); and
transmit the first image stored in the frame buffer to the second information processing apparatus (step S8).

The processor of the second information processing apparatus is configured to:
transmit the second input data based on an input to the controller device that is provided in the second information processing apparatus or the controller device that is that is connected to the second information processing apparatus to the first information processing apparatus (step S21); and
output the first image received from the first information processing apparatus to one of the display devices (step S24).

According to the configuration above, a user can play a game in a novel way such that a two-screen game is played using two information processing apparatuses. In addition, a user can play the game by performing game operations on an information processing apparatus that is not compatible with the game program (specifically, the information processing apparatus 1d).

Note that it is assumed in the description of FIG. 13 and FIG. 14 that the processes of steps S4, S10 to S12 shown in FIG. 9 and steps S22, S26, and S27 shown in FIG. 10 are not executed, but in the second example, as in the first example, the game system 10 may also accept a switching instruction to switch between the third mode and the fourth mode. Note that the input for a switching instruction may be accepted on the parent apparatus, may be accepted on the child apparatus, or may be accepted on both the parent apparatus and the child apparatus. In addition, the game system 10 may accept a switching instruction during the game, or may accept a switching instruction when the game is not being executed.

In the second example, since the game process is executed in the information processing apparatus 1a in either the third mode or the fourth mode, the information processing apparatus 1a does not need to generate and transmit the execution status data. That is, in the second example, in response to a switching instruction being given, the information processing apparatus 1a switches the input (e.g., switches between using an input made thereto and using operation data received from the information processing apparatus 1d), and switches the output of the game image (e.g., switches between displaying the first game image thereon while transmitting the second game image and displaying the second game image thereon while transmitting the first game image). In addition, the information processing apparatus 1d displays the game image received from the information processing apparatus 1a in either mode, and in response to a switching instruction being given, the information processing apparatus 1d switches between transmitting and not transmitting operation data to the information processing apparatus 1a. Note that in order to prevent the game from progressing while switching between modes, the information processing apparatus 1a may pause the game, as in the first example, from when the switching instruction is given until the mode switching is complete.

### Third Example

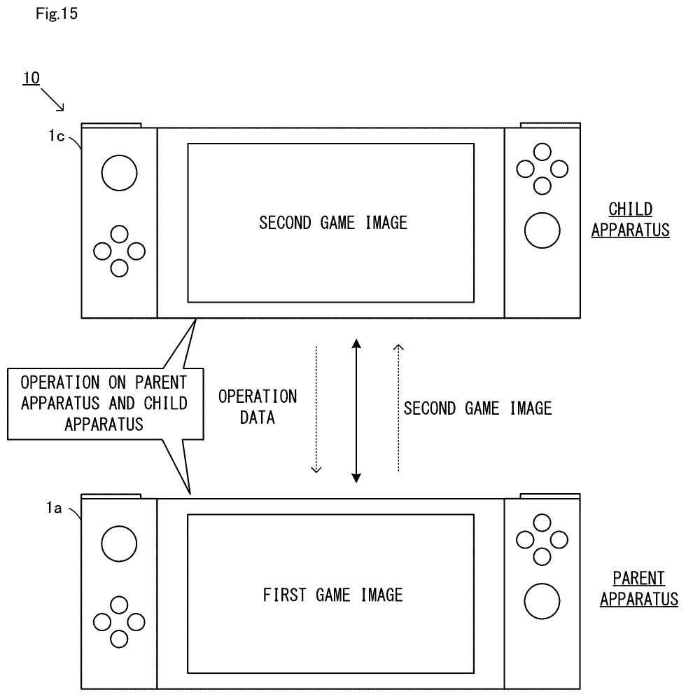

FIG. 15 is a diagram showing an example of the game system 10 in the third example. In the third example, a two-screen game is executed in the game system 10 that includes the two information processing apparatuses 1a and 1c as in the first example. Here, in the third example, the user performs game operations using both of the two information processing apparatuses 1a and 1c. Note that it is assumed that the two information processing apparatuses are of the same type in the third example as in the first example, but the two information processing apparatuses may be of different types as in the second example. For example, also in the third example, as in the second example, the information processing apparatus 1c may be an information processing apparatus such as a smartphone.

In FIG. 15, the information processing apparatus 1a operates as a parent apparatus and the information processing apparatus 1c operates as a child apparatus. In the third example, the game system 10 accepts a user input on the information processing apparatuses 1a and 1c. The information processing apparatus 1c transmits operation data based on a user input made thereto to the information processing apparatus 1a, which is the parent apparatus (see FIG. 15). The information processing apparatus 1a executes the game process based on an input made thereto and the operation data received from the information processing apparatus 1c. The information processing apparatus 1a generates the first and second game images based on the results of the game process, and stores the first and second game images in the first and second frame buffers, respectively. The information processing apparatus 1a displays the first game image on the display 12 thereof (or the stationary monitor 5 connected thereto), and transmits the second game image to the information processing apparatus 1c (see FIG. 15). The information processing apparatus 1c displays the received second game image on the display 12 thereof (or the stationary monitor 5 connected thereto). Note that in other embodiments, the first game image may be displayed on the child apparatus (e.g., the information processing apparatus 1c), and the second game image may be displayed on the parent apparatus (e.g., the information processing apparatus 1a).

As described above, in the third example, the user can perform game operations using both of the two information processing apparatuses 1a and 1c. Note that an input accepted by the information processing apparatus 1a and an input accepted by the information processing apparatus 1c are used as different instructions in the game. For example, an input to a predetermined button of the information processing apparatus 1a is used as an instruction to make the player character perform an attack action in the game, and an input to the same predetermined button of the information processing apparatus 1c may be used as an instruction to display a menu image in the game. Note however that some of the inputs to the information processing apparatuses 1a and 1c may be used as the same instruction in the game. For example, a certain button of the information processing apparatus 1a and a certain button of the information processing apparatus 1c may both be used as an instruction to make the player character perform a specific action in the game.

The two-screen game may be executable using the two information processing apparatuses as described above, as well as being executable using a single information processing apparatus of another type (e.g., an information processing apparatus having two screens). Even if the number of input sections (e.g., buttons) of this information processing apparatus is greater than the number of input sections of an information processing apparatus 1, it is possible to prevent the number of input sections from being insufficient by using two information processing apparatuses 1 according to the third example. Where the game is executed in the information processing apparatus of another type, a predetermined instruction may be given by a combination of a plurality of inputs (e.g., an input in which the first button and the second button are pressed simultaneously, or an input in which the first button is pressed and then the second button is pressed). In contrast, in the third example, the predetermined instruction can be given by a single input by assigning the predetermined instruction to a predetermined input to the second information processing apparatus.

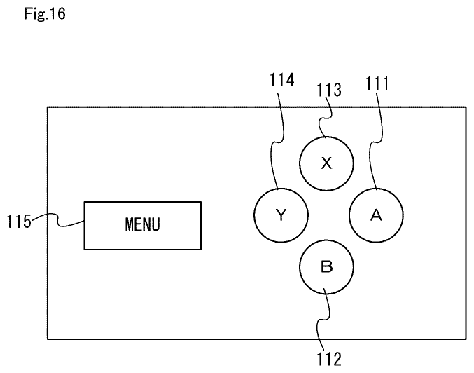

In the third example, an input to the touch panel of the child apparatus may be used for giving a game instruction, in addition to using an input to the touch panel of the parent apparatus for giving a game instruction. Then, one or both of the two game images may include an instruction image that indicates an instruction by a touch input. FIG. 16 is a diagram showing an example of a game image displayed in the third example. The game image shown in FIG. 16 includes instruction images 111 to 115. The instruction images 111 to 114 indicate buttons of the information processing apparatus (e.g., the A button, the B button, the X button, and the Y button). The instruction image 115 indicates an instruction to open a menu image. Thus, an instruction image may be an image representing an input section used for making an input, or an image representing the content of an instruction to be given by the input. In addition to the above, an instruction image may be an image representing a directional pad or a seek bar, for example. Note that the game image may be such that the instruction images are displayed in one area while the image of the game space is displayed in another area.

Here, where a predetermined instruction is assigned to a predetermined input made by a button operation in the game program for the two-screen game (e.g., it is defined in the game program so that a predetermined instruction is determined to have been given in response to a predetermined input being made), the instruction image representing this button operation may be included in the game image. The user can give the predetermined instruction by touching the instruction image on the screen. Note that the predetermined instruction is different from instructions that are given by an input to buttons of the information processing apparatuses 1a and 1c, for example. Then, it is possible to give more instructions than when giving instructions by an input to buttons of the information processing apparatuses 1a and 1c, thereby improving the operability of the game. For example, where it is not possible to assign the predetermined instruction to a button due to the limitation on the number of buttons of the information processing apparatuses 1a and 1c, the instruction image may be displayed so that the predetermined instruction can be given by a touch input.

Next, the details of the processes performed by the game system 10 in the third example will be described. First, the data stored in the information processing apparatuses 1a and 1d will be described. In the third example, the information processing apparatus 1a, which is the parent apparatus, stores data similar to the data shown in FIG. 8. The information processing apparatus 1c, which is the child apparatus, stores the connection partner apparatus data, the child apparatus operation data, and the child apparatus image data, among the data shown in FIG. 8.

FIG. 17 is a flowchart showing an example of the flow of the parent apparatus process in the third example. Note that, in the description of FIG. 17 below, like processes to those of the parent apparatus process shown in FIG. 9 or FIG. 13 will be denoted by like step numbers, and will not be described in detail.

In the parent apparatus process shown in FIG. 17, the processes of steps S1 to S3 and S5 to S9 are executed in the same way as the parent apparatus process shown in FIG. 9. Note that in the third example, in the game process of step S5, the processor 81 performs the game process based on the parent apparatus operation data and the child apparatus operation data. Thus, inputs to both of the two information processing apparatuses 1a and 1c will be reflected in the game. In the third example, the first game image is output as the parent apparatus image data in step S7, and the second game image is output as the child apparatus image data in step S8.

Note that the flow of the child apparatus process in the third example is similar to the flow of the child apparatus process in the second example shown in FIG. 14. Note that in the third example, the second game image is received and output as the child apparatus image data in steps S23 and S24.

Note that it is assumed in the third example that the processes of steps S4, S10 to S12 shown in FIG. 9 and steps S22, S26, and S27 shown in FIG. 10 are not executed, but also in the third example, as in the first example, it may be possible to switch between the parent apparatus and the child apparatus. Therefore, it is possible to improve the convenience for the user. Then, in response to a switching instruction being given, the game system 10 switches around the instructions assigned to the input sections of the information processing apparatus between the parent apparatus and the child apparatus. That is, the game system 10 executes the game process by assigning instructions that were assigned to the input sections of the parent apparatus before the switching instruction to the input sections of the child apparatus after the switching, and assigning instructions that were assigned to the input sections of the child apparatus before the switching instruction to the input sections of the parent apparatus after the switching.

As described above, in the third example, an information processing system (e.g., the game system 10) causes a processor of an information processing apparatus to execute a game program for performing a game process based on operation data to generate a first game image to be displayed on a first screen and a second game image to be displayed on a second screen. A first game apparatus (e.g., the information processing apparatus 1a) and a second game apparatus (e.g., the information processing apparatus 1c) included in the information processing system each include at least one processor and are each configured to:
acquire input data based on an input to at least one of a controller device that is provided in the game apparatus (e.g., the first controller) and a controller device that is connected to the game apparatus (e.g., the second controller); and
output an image to one of a display device that is provided in the game apparatus (e.g., the display 12) and a display device that is connected to the game apparatus (e.g., the stationary monitor 5).

The first information processing apparatus and the second information processing apparatus communicate with each other. The processor of the first information processing apparatus is configured to:
acquire first input data based on an input to the controller device that is provided in the first information processing apparatus or the controller device that is connected to the first information processing apparatus (step S2);
acquire second input data from the second information processing apparatus (step S3);
execute the game program using the first input data and the second input data as the operation data (step S5);
store a first image and a second image in a frame buffer (step S6);
transmit one of the first image and the second image stored in the frame buffer to the second information processing apparatus (step S8); and
output the other one of the first image and the second image stored in the frame buffer to one of the display devices (step S7).

The processor of the second information processing apparatus is configured to:
transmit the second input data based on an input to the controller device that is provided in the second information processing apparatus or the controller device that is connected to the second information processing apparatus to the first information processing apparatus (step S21); and
output one of the first image and the second image received from the first information processing apparatus to one of the display devices (step S24).

According to the configuration above, a user can play a game in a novel way such that a two-screen game is played using two information processing apparatuses. In addition, since inputs to two information processing apparatuses are accepted, a user can perform game operations using more input sections, thereby improving the operability of the game.

In the third example, in the game program, inputs by a plurality of key operations are used for giving instructions in the game. At least one of the first information processing apparatus and the second information processing apparatus further includes a touch panel, and touch input data of the touch panel is included in at least one of the first input data and the second input data. The processor of the first information processing apparatus generates an image including an image indicating a key operation as either of the first image and the second image (see FIG. 16). In response to an input of touching an image indicating a key operation, the processor of the first information processing apparatus executes the game program as if the key operation has been performed (step S5).

According to the configuration above, instructions for a two-screen game can be given by touch input, thereby improving the operability of the game.

Note that, in the embodiment described above, where a process is executed using data (meaning including a program) in a first information processing apparatus, a part of the data necessary for the process may be transmitted from a second information processing apparatus that is different from the first information processing apparatus. In this case, the first information processing apparatus may execute the process using data stored therein and data received from the second information processing apparatus.

Note that in other embodiments, the information processing system does not need to include some of the components of the embodiment described above and does not need to execute some of the processes that are executed in the embodiment described above. For example, in order to realize some particular effects of the embodiment described above, the information processing system may only need to include a component or components for realizing said effects and execute a process or processes for realizing said effects, and the information processing system does not need to include other components and does not need to execute other processes.

The embodiment described above can be used as a game system or a game program, for example, with the aim of playing games in novel and diverse ways, for example.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information processing system that causes a processor of a game apparatus to execute a game program for performing a game process based on operation data to generate a first image to be displayed on a first screen and a second image to be displayed on a second screen, the information processing system comprising:
a first game apparatus and a second game apparatus, wherein:
the first game apparatus includes at least one processor, and is configured to:
acquire input data based on an input to at least one of a controller device that is provided in the first game apparatus and a controller device that is connected to the first game apparatus; and
output an image to one of a display device that is provided in the first game apparatus and a display device that is connected to the first game apparatus;
the second game apparatus includes at least one processor, and is configured to:
acquire input data based on an input to at least one of a controller device that is provided in the second game apparatus and a controller device that is connected to the second game apparatus; and
output an image to one of a display device that is provided in the second game apparatus and a display device that is connected to the second game apparatus;
the first game apparatus and the second game apparatus communicate with each other; and
in the first mode,
the at least one processor of the first game apparatus is configured to:
acquire first input data based on an input to one of the controller device that is provided in the first game apparatus and the controller device that is connected to the first game apparatus;
execute the game program using the first input data as the operation data;
store the first image and the second image in a frame buffer;
output the first image stored in the frame buffer to the display device that is provided in the first game apparatus or the display device that is connected to the first game apparatus; and
transmit the second image stored in the frame buffer to the second game apparatus; and
the at least one processor of the second game apparatus is configured to:
output the second image received from the first game apparatus to the display device that is provided in the second game apparatus or the display device that is connected to the second game apparatus.

2. The information processing system according to claim 1, wherein:
in the second mode,
the at least one processor of the second game apparatus is configured to:
execute the game program using the first input data received from the first game apparatus as the operation data;
store the first image and the second image in a frame buffer;
output the first image stored in the frame buffer to the display device that is provided in the second game apparatus or the display device that is connected to the second game apparatus; and
transmit the second image stored in the frame buffer to the first game apparatus; and
the at least one processor of the first game apparatus is configured to:
transmit the first input data to the second game apparatus; and
output the second image received from the second game apparatus to the display device that is provided in the first game apparatus or the display device that is connected to the first game apparatus.

3. The information processing system according to claim 2, wherein:
the information processing system is configured to switch between the first mode and the second mode by an instruction input;
when transitioning from the first mode to the second mode,
the at least one processor of the first game apparatus transmits execution status data that indicates an execution status of the game program to the second game apparatus; and
the at least one processor of the second game apparatus resumes execution of the game program based on the received execution status data; and
when transitioning from the second mode to the first mode,
the at least one processor of the second game apparatus transmits the execution status data to the first game apparatus; and
the at least one processor of the first game apparatus resumes execution of the game program based on the received execution status data.

4. An information processing system that causes a processor of a game apparatus to execute a game program for performing a game process based on operation data to generate a first image to be displayed on a first screen and a second image to be displayed on a second screen, the information processing system comprising:
a first game apparatus and a second game apparatus, wherein:
the first game apparatus includes at least one processor, and is configured to:
acquire input data based on an input to at least one of a controller device that is provided in the first game apparatus and a controller device that is connected to the first game apparatus; and
output an image to one of a display device that is provided in the first game apparatus and a display device that is connected to the first game apparatus;
the second game apparatus includes at least one processor, and is configured to:
acquire input data based on an input to at least one of a controller device that is provided in the second game apparatus and a controller device that is connected to the second game apparatus; and
output an image to one of a display device that is provided in the second game apparatus and a display device that is connected to the second game apparatus;
the first game apparatus and the second game apparatus communicate with each other;
the at least one processor of the first game apparatus is configured to:
acquire second input data from the second game apparatus;
execute the game program using the second input data as the operation data;
store the first image and the second image in a frame buffer;
output the second image stored in the frame buffer to the display device that is provided in the first game apparatus or the display device that is connected to the first game apparatus; and
transmit the first image stored in the frame buffer to the second game apparatus; and
the at least one processor of the second game apparatus is configured to:
transmit the second input data based on an input to the controller device that is provided in the second game apparatus or the controller device that is connected to the second game apparatus to the first game apparatus; and
output the first image received from the first game apparatus to the display device that is provided in the second game apparatus or the display device that is connected to the second game apparatus.

5. An information processing system that causes a processor of a game apparatus to execute a game program for performing a game process based on operation data to generate a first image to be displayed on a first screen and a second image to be displayed on a second screen, the information processing system comprising:
a first game apparatus and a second game apparatus, wherein:
the first game apparatus includes at least one processor, and is configured to:
acquire input data based on an input to at least one of a controller device that is provided in the first game apparatus and a controller device that is connected to the first game apparatus; and
output an image to one of a display device that is provided in the first game apparatus and a display device that is connected to the first game apparatus;
the second game apparatus includes at least one processor, and is configured to:
acquire input data based on an input to at least one of a controller device that is provided in the second game apparatus and a controller device that is connected to the second game apparatus; and
output an image to one of a display device that is provided in the second game apparatus and a display device that is connected to the second game apparatus;
the first game apparatus and the second game apparatus communicate with each other;
the at least one processor of the first game apparatus is configured to:
acquire first input data based on an input to the controller device that is provided in the first game apparatus or the controller device that is connected to the first game apparatus;
acquire second input data from the second game apparatus;
execute the game program using the first input data and the second input data as the operation data;
store the first image and the second image in a frame buffer;
transmit one of the first image and the second image stored in the frame buffer to the second game apparatus; and
output the other one of the first image and the second image stored in the frame buffer to the display device that is provided in the first game apparatus or the display device that is connected to the first game apparatus; and
the at least one processor of the second game apparatus is configured to:
transmit the second input data based on an input to the controller device that is provided in the second game apparatus or the controller device that is connected to the second game apparatus to the first game apparatus; and
output one of the first image and the second image received from the first game apparatus to the display device that is provided in the second game apparatus or the display device that is connected to the second game apparatus.

6. The information processing system according to claim 5, wherein:
in the game program, inputs by a plurality of key operations are used for giving instructions in the game;
at least one of the first game apparatus and the second game apparatus further includes a touch panel, and touch input data of the touch panel is included in at least one of the first input data and the second input data; and
at least one processor of the first game apparatus is configured to:
generate an image including an image indicating a key operation as either of the first image and the second image; and
in response to an input of touching an image indicating a key operation, execute the game program as if the key operation has been performed.

7. An information processing method to be executed in an information processing system that executes a game program for performing a game process based on operation data to generate a first image to be displayed on a first screen and a second image to be displayed on a second screen, wherein:
the information processing system includes a first game apparatus and a second game apparatus;
the first game apparatus:
acquires input data based on an input to at least one of a controller device that is provided in the first game apparatus and a controller device that is connected to the first game apparatus; and
outputs an image to one of a display device that is provided in the first game apparatus and a display device that is connected to the first game apparatus;
the second game apparatus:
acquires input data based on an input to at least one of a controller device that is provided in the second game apparatus and a controller device that is connected to the second game apparatus; and
outputs an image to one of a display device that is provided in the second game apparatus and a display device that is connected to the second game apparatus;
the first game apparatus and the second game apparatus are configured to communicate with each other; and
in the first mode,
the first game apparatus:
acquires first input data based on an input to the controller device that is provided in the first game apparatus or the controller device that is connected to the first game apparatus;
executes the game program using the first input data as the operation data;
stores the first image and the second image in a frame buffer;
outputs the first image stored in the frame buffer to the display device that is provided in the first game apparatus or the display device that is connected to the first game apparatus; and
transmits the second image stored in the frame buffer to the second game apparatus; and
the second game apparatus:
outputs the second image received from the first game apparatus to the display device that is provided in the second game apparatus or the display device that is connected to the second game apparatus.

8. The information processing method according to claim 7, wherein:
in the second mode,
the second game apparatus:
executes the game program using the first input data received from the first game apparatus as the operation data;
stores the first image and the second image in a frame buffer;
outputs the first image stored in the frame buffer to the display device that is provided in the second game apparatus or the display device that is connected to the second game apparatus; and
transmits the second image stored in the frame buffer to the first game apparatus; and
first game apparatus:
transmits the first input data to the second game apparatus; and
outputs the second image received from the second game apparatus to the display device that is provided in the first game apparatus or the display device that is connected to the first game apparatus.

9. The information processing method according to claim 8, wherein:
the information processing system is configured to switch between the first mode and the second mode by an instruction input;
when transitioning from the first mode to the second mode,
the first game apparatus transmits execution status data that indicates an execution status of the game program to the second game apparatus; and
the second game apparatus resumes execution of the game program based on the received execution status data; and
when transitioning from the second mode to the first mode,
the second game apparatus transmits the execution status data to the first game apparatus; and
the first game apparatus resumes execution of the game program based on the received execution status data.

10. An information processing method to be executed in an information processing system that executes a game program for performing a game process based on operation data to generate a first image to be displayed on a first screen and a second image to be displayed on a second screen, wherein:
the information processing system includes a first game apparatus and a second game apparatus;
the first game apparatus:
acquires input data based on an input to at least one of a controller device that is provided in the first game apparatus and a controller device that is connected to the first game apparatus; and
outputs an image to one of a display device that is provided in the first game apparatus and a display device that is connected to the first game apparatus;
the second game apparatus:
acquires input data based on an input to at least one of a controller device that is provided in the second game apparatus and a controller device that is connected to the second game apparatus; and
outputs an image to one of a display device that is provided in the second game apparatus and a display device that is connected to the second game apparatus;
the first game apparatus and the second game apparatus are configured to communicate with each other;
the first game apparatus:
acquires second input data from the second game apparatus;
executes the game program using the second input data as the operation data;
stores the first image and the second image in a frame buffer;
outputs the second image stored in the frame buffer to the display device that is provided in the first game apparatus or the display device that is connected to the first game apparatus; and
transmits the first image stored in the frame buffer to the second game apparatus; and
the second game apparatus:
transmits the second input data based on an input to the controller device that is provided in the second game apparatus or the controller device that is connected to the second game apparatus to the first game apparatus; and
outputs the first image received from the first game apparatus to the display device that is provided in the second game apparatus or the display device that is connected to the second game apparatus.

11. An information processing method to be executed in an information processing system that executes a game program for performing a game process based on operation data to generate a first image to be displayed on a first screen and a second image to be displayed on a second screen, wherein:
the information processing system includes a first game apparatus and a second game apparatus;
the first game apparatus:
acquires input data based on an input to at least one of a controller device that is provided in the first game apparatus and a controller device that is connected to the first game apparatus; and
outputs an image to one of a display device that is provided in the first game apparatus and a display device that is connected to the first game apparatus;
the second game apparatus:
acquires input data based on an input to at least one of a controller device that is provided in the second game apparatus and a controller device that is connected to the second game apparatus; and
outputs an image to one of a display device that is provided in the second game apparatus and a display device that is connected to the second game apparatus;
the first game apparatus and the second game apparatus are configured to communicate with each other;
the first game apparatus:
acquires first input data based on an input to the controller device that is provided in the first game apparatus or the controller device that is connected to the first game apparatus;
acquires second input data from the second game apparatus;
executes the game program using the first input data and the second input data as the operation data;
stores the first image and the second image in a frame buffer;
transmit one of the first image and the second image stored in the frame buffer to the second game apparatus; and
outputs the other one of the first image and the second image stored in the frame buffer to the display device that is provided in the first game apparatus or the display device that is connected to the first game apparatus; and
the second game apparatus:
transmits the second input data based on an input to the controller device that is provided in the second game apparatus or the controller device that is connected to the second game apparatus to the first game apparatus; and
outputs one of the first image and the second image received from the first game apparatus to the display device that is provided in the second game apparatus or the display device that is connected to the second game apparatus.

12. The information processing method according to claim 11, wherein:
in the game program, inputs by a plurality of key operations are used for giving instructions in the game;
at least one of the first game apparatus and the second game apparatus further includes a touch panel, and touch input data of the touch panel is included in at least one of the first input data and the second input data; and
the first game apparatus:
generates an image including an image indicating a key operation as either of the first image and the second image; and
in response to an input of touching an image indicating a key operation, executes the game program as if the key operation has been performed.
